(19) United States
(12) Patent Application Publication
(10) Pub. No.: US 2010/0217922 A1
(43) Pub. Date: Aug. 26, 2010

(54) ACCESS MODULE, STORAGE MODULE, MUSICAL SOUND GENERATING SYSTEM AND DATA WRITING MODULE

(76) Inventor: Masahiro Nakanishi, Kyoto (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/671,258

(22) PCT Filed: Mar. 17, 2009
(86) PCT No.: PCT/JP2009/001171

§ 371 Date: Jan. 29, 2010

(30) Foreign Application Priority Data
Jul. 24, 2008 (JP) 2008-190617

(51) Int. Cl. G06F 12/02; G06F 12/00; G06F 3/00; G06F 17/30

(52) U.S. Cl. 711/103; 711/102; 710/51; 707/824; 710/15; 707/E17.01; 711/E12.001; 711/E12.008

(57) ABSTRACT

An access module is connected to a storage module which stores multiplexed musical sound data in a non-compressed form. Based on a read request status of each sounding channel and access status of the nonvolatile storage module as a read target, a read instructing part transfers a read instruction to the storage module and reads musical sound data in parallel from the storage modules. In this musical sound generating system, since a plurality of pieces of musical sound data can be read from a plurality of nonvolatile storage modules in parallel, a sounding delay time can be made smaller than an acceptable time. For this reason, a prevailing mass NAND flash memory can be used as a memory for the musical sound data, thereby realizing a high sound quality and compact musical sound generating system.

### TECHNICAL FIELD

The present invention relates to an access module for generating musical sound by reading musical sound data such as musical instrumental sound from a plurality of nonvolatile storage modules which previously store the musical sound data therein and performing signal processing of the musical sound data, a storage module including the plurality of nonvolatile storage modules, a musical sound generating system including the plurality of nonvolatile storage modules and access module, and a data writing module for writing the musical sound data to the nonvolatile storage modules.

### BACKGROUND ART

The nonvolatile storage module provided with a rewritable nonvolatile memory typified by a semiconductor memory card as a removable storage device is now in increasing demand. Although the semiconductor memory card is much more expensive than an optical disc or a tape media, it is in great demand as a recording medium for portable equipment such as a digital still camera and mobile phone due to advantages such as a compact size, light weight, seismic performance and convenience in handling.

The semiconductor memory card includes a flash memory as a nonvolatile main memory and a memory controller for controlling the flash memory. According to a reading/writing instruction from the access module such as a digital still camera, the memory controller performs reading/writing control of the flash memory. A non-removable nonvolatile storage module is incorporated into the digital still camera or a portable audio equipment, or incorporated into a personal computer as an alternative of a hard disc.

The flash memory includes a memory cell array and an I/O register (RAM) for temporarily holding data read from the memory cell array or data written from the outside therein. Since the flash memory takes a relatively long time to write or erase data to or from memory cells forming the memory cell array, it can collectively erase or write data from or to the plurality of memory cells. Specifically, the flash memory includes a plurality of physical blocks and each physical block contains a plurality of pages. Erasure of data is performed in units of physical block and writing of data is performed in units of page.

There is a musical sound generating system which holds musical sound data of an electronic musical instrument or the like in a ROM. The musical sound generating system is a system for generating sound of the musical instrument (hereinafter referred to as musical sound) according to an operation of touching a key and the like. The musical sound generating system has 32 or more sounding channels and generates musical sound by allocating the sounding channels in the order of key-touch. In this system, since musical sound must be generated corresponding to the random key-touch operation, a mask ROM having a high random reading speed is used as the ROM for the musical sound data.

In Patent document 1, it is predicted that the bit unit cost of the flash memory becomes smaller than that of the mask ROM with a technical progress of the flash memory. Patent document 1 discloses a technique of reducing system costs by using the flash memory having a lower random reading speed than that of the mask ROM as the ROM for the musical sound data.

As predicted in Patent document 1, the dominating flash memory is a gigabit class multi-level NAND flash memory (hereinafter referred to as a mass flash memory) which addresses a demand for an increase in capacity and reduction of cost by value multiplexing and process shrinking. Thereby, the flash memory has much more inexpensive bit unit cost and much larger capacity per unit area than those of the mask ROM, increasingly enabling reduction of price and size of the system.

A binary NAND flash memory (product number: TC58V64FT) used in an embodiment of Patent document 1 is an old type small-capacity and high-speed binary NAND flash memory whose capacity is 64 Mbits and read time required to access from a memory cell array to an I/O register and read data (hereinafter referred to as TR) is 7 μseconds.

Patent document 1: Japanese Unexamined Patent Publication No. 2000-284783

### DISCLOSURE OF INVENTION

### Problem to be Solved by the Invention

Here, a high sound quality musical sound generating system which stores non-compressed musical sound data acquired by digitally recording musical instrumental sound from a piano or the like in a mask ROM or an NAND flash memory to maintain a high sound quality will be considered. In this case, given that a sampling frequency is 44.1 kHz, a sounding time per key is 40 seconds, word length per sample of the musical sound data is 2 Bytes and the number of keys of the piano is 88, when two kinds of touches: the strongest key-touch and weakest key-touch are recorded, a capacity of about 621 MBytes is needed as represented by a formula (1).

44.1×40×2×2×88=about 621 MBytes (1)

Therefore, when using the above-mentioned binary NAND flash memory having the capacity of 64 Mbits, it is need to implement about 78 NAND flash memories as represented by a formula (2).

621 Mbytes÷64 Mbits=about 78 (2)

Therefore, reduction of size of a musical sound generating system is difficult.

Meanwhile, when using the prevailing gigabit class multi-level NAND flash memory, by implementing one or a few multi-level NAND flash memories, the musical sound data of 621 MBytes can be stored without being compressed.

However, in the multi-level NAND flash memory, since extension of the page size and multiplexing are carried out to increase the speed of reading/writing mass data at one time, read time TR becomes 50 μseconds, which is unduly long. In the musical sound generating system, it is generally required to simultaneously sound 32 channels. However, when an attempt is made to generate musical sound of 32nd channel, a sounding delay time is at least 1.6 mseconds as represented by a formula (3).

Sounding delay time=50 μseconds×32=1.6 mseconds (3)

The sounding delay time means a period from the key-touch operation to start of sounding and its acceptable scope is generally defined to be within 1 msecond. When the sounding delay time exceeds 1 msecond, it causes uncomfortable feeling in terms of musical performance and the musical sound generating system does not make an effect.

Thus, an object of the present invention is to provide an access module, a storage module, a musical sound generating system and a data writing module which can realize a high sound quality and a compact musical sound generating system even when the memory such as the prevailing mass flash memory is used as the memory for the musical sound data.

### Means to Solve the Problems

To solve the problems, an access module of the present invention is a module for providing a read instruction to a plurality of nonvolatile storage modules recording multiplexed musical sound data therein comprising: a read instructing part for reading data from any of said nonvolatile storage modules according one external sounding instruction, and parallely reading data from the nonvolatile storage module other than the reading nonvolatile storage module when another sounding instruction is provided before the reading is completed.

Said access module may further comprise a CPU part for assigning a plurality of external sounding instructions to a plurality of sounding channels and said read instructing part provides a read instruction to any of said plurality of nonvolatile storage modules based on the plurality of sounding channels assigned by said CPU part.

Said read instructing part may include a channel register for registering a state of said read instruction to said nonvolatile storage module for each sounding channel.

Said read instructing part may include an MM register for registering access state for each of said nonvolatile storage modules.

In the access module, at least one of said plurality of nonvolatile storage modules holds recorded data characteristic information including at least information on a sampling frequency of said musical sound data therein, and said access module further comprises an input and output part for performing music sound generating processing based on said recorded data characteristic information acquired from said nonvolatile storage module.

To solve the problems, an access module of the present invention is a module for performing reading and writing with respect to a plurality of nonvolatile storage modules comprising: a CPU part including a multiplexing part for multiplexing musical sound data acquired from outside and a file system part for managing musical sound data held in said plurality of nonvolatile storage modules as a file; a write instructing part for recording said musical sound data multiplexed by said multiplexing part in said plurality of nonvolatile storage modules; and a read instructing part for reading data from any of said nonvolatile storage modules according one external sounding instruction, and parallely reading data from the nonvolatile storage module other than the reading nonvolatile storage module when another sounding instruction is provided before the reading is completed.

Said CPU part may have a function of assigning a plurality of external sounding instructions to a plurality of sounding channels, and said read instructing part provides a read instruction to any of said plurality of nonvolatile storage modules based on the plurality of sounding channels assigned by said CPU part.

said read instructing part may include a channel register for registering the state of said read instruction to said nonvolatile storage module for each of said sounding channels.

said read instructing part may include an MM register for registering an access state for each of said nonvolatile storage modules.

In the access module, at least one of said plurality of nonvolatile storage modules holds recorded data characteristic information including at least information on a sampling frequency of said musical sound data therein, said access module further comprises an input and output part for performing music sound generating processing based on said recorded data characteristic information acquired from said nonvolatile storage module.

To solve the problems, a storage module of the present invention comprises: a plurality of nonvolatile storage modules each recording the same musical sound data therein, and reading data in parallel according to an external read instruction.

To solve the problems, a musical sound generating system of the present invention comprises: an access module; and a plurality of nonvolatile storage modules for reading data in parallel according to a read instruction from said access module, wherein: said plurality of nonvolatile storage modules each record the same musical sound data; and said access module includes a read instructing part for reading data from any of said nonvolatile storage modules according one external sounding instruction, and parallely reading data from the nonvolatile storage module other than the reading nonvolatile storage module when another sounding instruction is provided before the reading is completed.

Said nonvolatile storage module may include a multi-level NAND flash memory as a memory bank.

To solve the problems, a musical sound generating system of the present invention comprises: an access module; and a plurality of nonvolatile storage modules for reading data in parallel according to a read instruction from said access module, wherein: said plurality of nonvolatile storage modules each record the same musical sound data; and said access module includes: a CPU part including a multiplexing part for multiplexing musical sound data acquired from outside and a file system part for managing musical sound data held in said plurality of nonvolatile storage modules as a file; a write instructing part for recording said musical sound data multiplexed by said multiplexing part in said plurality of nonvolatile storage modules; and a read instructing part for reading data from any of said nonvolatile storage modules according one external sounding instruction, and parallely reading data from the nonvolatile storage module other than the reading nonvolatile storage module when another sounding instruction is provided before the reading is completed.

Said nonvolatile storage module may include a multi-level NAND flash memory as a memory bank.

To solve the problems, a data writing module of the present invention connected to a plurality of nonvolatile storage modules for writing musical sound data comprises: a multiplexing part for multiplexing musical sound data acquired from outside; a file system part for managing said musical sound data multiplexed by said multiplexing part as a file; and a write instructing part for writing said musical sound data multiplexed by said multiplexing part to said plurality of nonvolatile storage modules.

To solve the problems, a data writing module of the present invention connected to a plurality of nonvolatile storage modules for writing musical sound data comprises: a multiplexing part for multiplexing musical sound data acquired from any of said plurality of nonvolatile storage modules; a file system part for managing said musical sound data multiplexed by said multiplexing part as a file; and a write instructing part for writing said musical sound data multiplexed by said multiplexing part to the other nonvolatile storage module of said plurality of nonvolatile storage modules.

said data writing module further may include an input and output part for detecting that any of connected nonvolatile storage modules holds musical sound data.

### EFFECTIVENESS OF THE INVENTION

According to the present invention, the musical sound data in a non-compressed form is multiplexed and recorded in a plurality of nonvolatile storage modules and a read instructing part of the access module reads the musical sound data in parallel from the plurality of nonvolatile storage modules according to an external sounding instruction. For this reason, in a system in which it cannot be predicted which pitch of musical sound data is required to be read, such as the musical sound generating system, a plurality of pieces of data can be read from the plurality of nonvolatile storage modules in parallel and the sounding delay time can be made smaller than 1 msecond as its acceptable scope. Therefore, the prevailing mass flash memory as the nonvolatile storage module can be used as the memory for the musical sound data, reducing price and size. The access module using the nonvolatile storage modules, and the musical sound generating system including the access module and nonvolatile storage modules can be realized.

### BRIEF DESCRIPTION OF DRAWINGS

FIG. 1A is a block diagram showing a storage module of a musical sound generating system according to a first embodiment of the present invention.

FIG. 1B is a block diagram showing an access module of a musical sound generating system according to the first embodiment of the present invention.

FIG. 2 is a diagram for describing a structure of memory cell arrays of nonvolatile memory banks 112 to 142.

FIG. 3 is a diagram showing a record format in each page using P0 of PB0.

FIG. 4 is a bit format showing a physical sector number PSN.

FIG. 5 is a block diagram showing a musical sound data buffer 231.

FIG. 6A is a diagram for describing a channel assign table 232.

FIG. 6B is a diagram for describing the channel assign table 232.

FIG. 6C is a diagram for describing the channel assign table 232.

FIG. 7 is a diagram for describing an NN table 233A.

FIG. 8 is a memory map showing a channel register 241.

FIG. 9 is a memory map showing an MM register 242.

FIG. 10 shows a bit format showing one sample of musical sound data.

FIG. 11 is an explanatory diagram showing characteristic information of piano musical sound data.

FIG. 12 is an explanatory diagram showing memory structure information.

FIG. 13A is a flow chart showing a main routine of CPU parts 230A, 230B.

FIG. 13B is a flow chart showing an interrupt routine of the CPU parts 230A, 230B.

FIG. 14A is a flow chart showing a main routine of a read instructing part 240.

FIG. 14B is a flow chart showing an interrupt routine 1 of the read instructing part 240.

FIG. 14C is a flow chart showing an interrupt routine 2 of the read instructing part 240.

FIG. 15 is a bit format showing read instructing information.

FIG. 16 is a bit format showing musical performance data.

FIG. 17 is a flow chart showing processing by a memory controller.

FIG. 18 is a time chart of a read command issued by the memory controller to a nonvolatile memory bank.

FIG. 19 is a bit format showing musical sound data read from storage modules 100A, 100B onto an external bus.

FIG. 20 is a flow chart showing processing by a signal processing part 220.

FIG. 21 is a graph showing time variation of LD after key-touch when a value of the PD is 0.

FIG. 22 is a graph showing time variation of LD after key-touch when the value of the PD is 1.

FIG. 23 is a time slot view showing signal processing per sampling cycle.

FIG. 24A is a time chart of the musical sound generating system.

FIG. 24B is a time chart of the musical sound generating system.

FIG. 24C is a time chart of the musical sound generating system.

FIG. 25A is a block diagram showing a storage module of a musical sound generating system according to a second embodiment of the present invention.

FIG. 25B is a block diagram showing an access module of the musical sound generating system according to the second embodiment of the present invention.

FIG. 26A is an explanatory diagram showing relationship between a logical address and LSN.

FIG. 26B is an explanatory diagram showing relationship between structure of nonvolatile memory banks 110B to 140B and LSN.

FIG. 27 is a diagram showing a record format in each page using P0 of PB0.

FIG. 28 is a bit format showing correspondence between LSN and PSN (physical sector number).

FIG. 29 is an explanatory diagram showing an NN table 233B.

FIG. 30A is a bit format showing read instructing information of memory structure information.

FIG. 30B is a bit format showing read instructing information of musical sound data and recorded data characteristic information.

FIG. 31 is a flow chart showing musical sound data writing processing by an access module 200B.

FIG. 32 is an explanatory diagram showing file allocation of musical sound data obtained through the Internet 310.

FIG. 33A is an explanatory diagram showing a storage state of nonvolatile memory banks 112 to 142 before writing of the musical sound data.

FIG. 33B is an explanatory diagram showing the storage state of the nonvolatile memory banks 112 to 142 after writing of the musical sound data.

FIG. 34 is a bit map showing write instruction information of the musical sound data.

FIG. 35 is a block diagram showing a writing module of a data writing system according to a third embodiment of the present invention.

FIG. 36 is a block diagram showing a writing module of a data writing system according to a forth embodiment of the present invention.

### DESCRIPTION OF REFERENCE NUMERALS

100A, 100B Storage module
110A, 110B, 120A, 120B, 130A, 130B, 140A, 140B Nonvolatile storage module
111A, 111B, 121A, 121B, 131A, 131B, 141A, 141B Memory controller
112, 122, 132, 142 Nonvolatile memory bank
113, 123, 133, 143 I/O register
114, 124, 134, 144 Memory cell array
200A, 200B Access module
210, 410, 510 Input and output part
220 Signal processing part
230, 420, 520 CPU part
231 Musical sound data buffer
231_0 to 231_3 Buffer
231_0a, 231_0b, 231_1a, 231_1b Dual port RAM
231_2a, 231_2b, 231_3a, 231_3b Dual port RAM
231_0c, 231_1c, 231_2c, 231_3c Multiplexer
231_0d, 231_1d, 231_2d, 231_3d Demultiplexer
232 Channel assign table
233A, 233B NN table
234 Musical performance data buffer
235 Transfer monitoring part
236 File system part
237 Multiplexing part
240 Read instructing part
250, 430, 530 Write instructing part
300 Master keyboard
310 Internet
400, 500 Data writing module

### BEST MODE FOR CARRYING OUT THE INVENTION

### First Embodiment

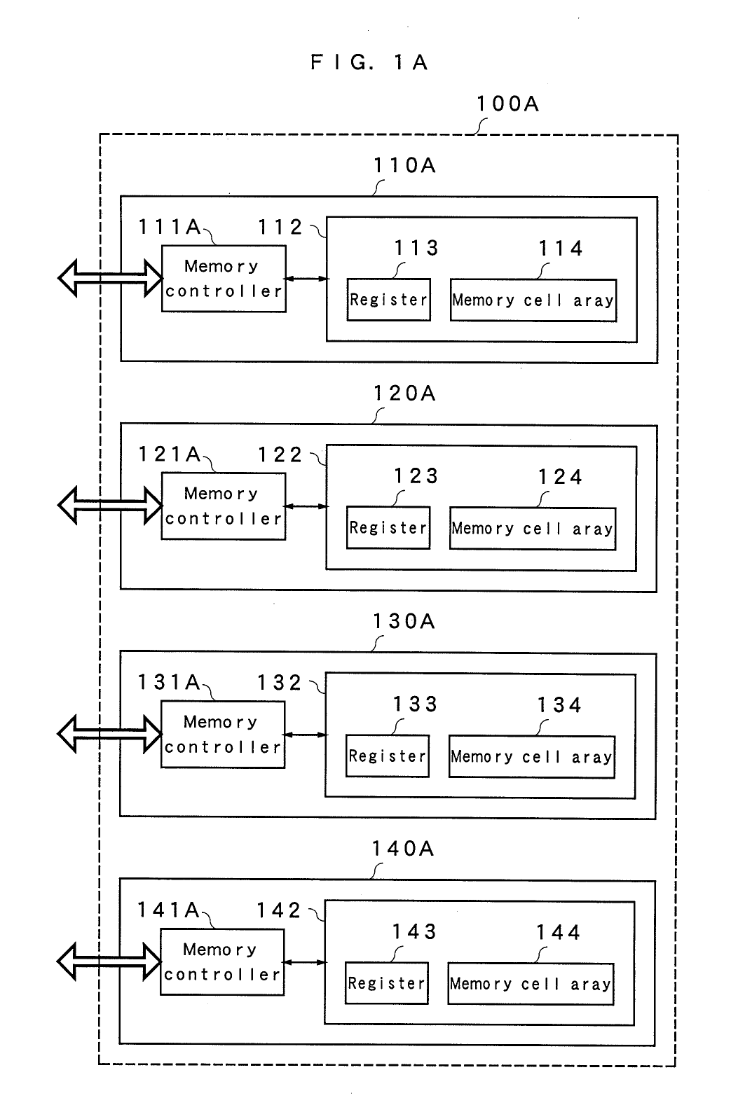

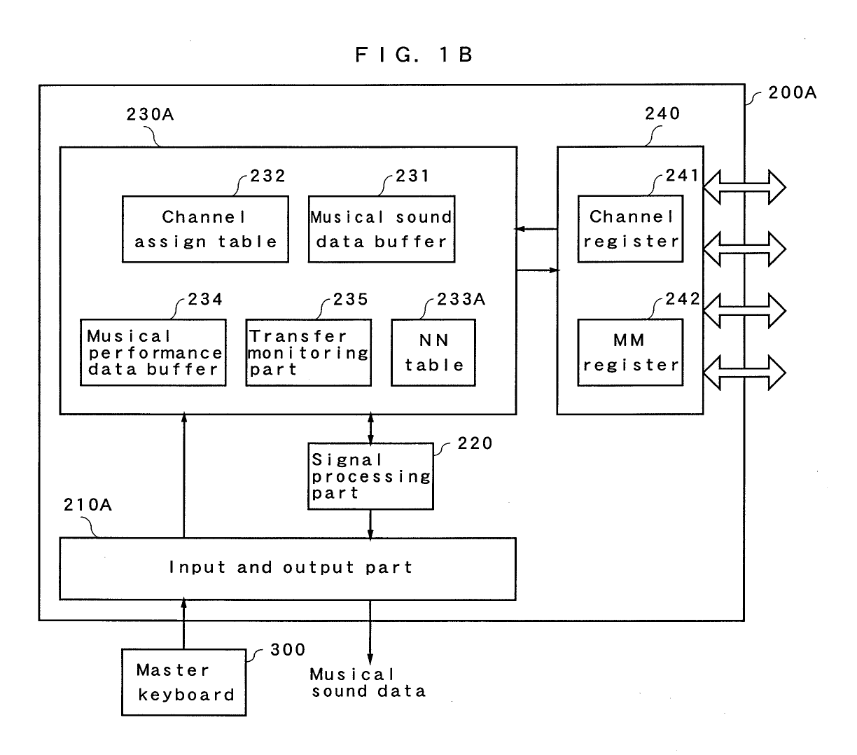

FIGS. 1A and 1B are block diagrams showing a musical sound generating system according to a first embodiment of the present invention. The musical sound generating system includes a storage module 100A shown in FIG. 1A and an access module 200A shown in FIG. 1B. The storage module 100A accommodates nonvolatile storage modules 110A, 120A, 130A, 140A in one housing and is attached to the access module for usage. The nonvolatile storage modules 110A, 120A, 130A, 140A include memory controllers 111A, 121A, 131A, 141A and nonvolatile memory banks 112, 122, 132, 142, respectively.

The access module 200A includes an input and output part 210A, a signal processing part 220, a CPU part 230A and a read instructing part 240 and can simultaneously outputs musical sound of 32 channels. Hereinafter, channel numbers are referred to as CH0 to CH31. The CPU part 230A includes a musical sound data buffer 231, a channel assign table 232, an NN table 233A, a musical performance data buffer 234 and a transfer monitoring part 235.

Next, each part of the nonvolatile storage modules 110A to 140A will be described in detail. The nonvolatile memory banks 112 to 142 are flash memories which include I/O registers 113, 123, 133, 143 and memory cell arrays 114, 124, 134, 144, respectively. Each of the I/O registers 113 to 143 is a RAM having a capacity of 4096 Bytes+128 Bytes. The memory cell arrays 114 to 144 each has 1024 physical blocks. The physical block is an erasure unit of the flash memory. Hereinafter, the physical block is referred to as PB, a physical block number is referred to PBN, a physical sector number is referred to as PBN and the physical block having the physical block number 0, for example, is referred to as PB0.

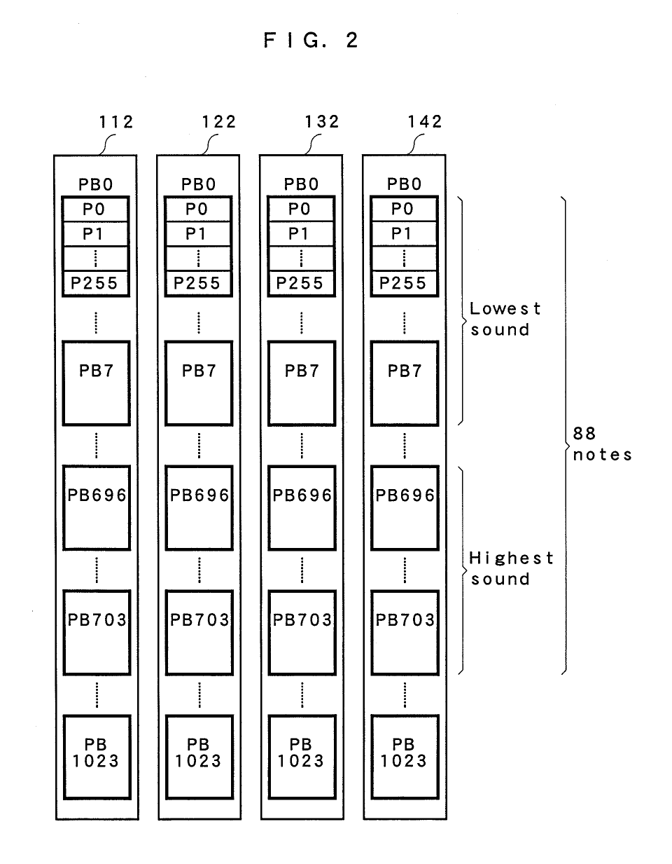

FIG. 2 is a diagram for describing a structure of the memory cell arrays of the nonvolatile memory banks 112 to 142. The nonvolatile memory banks 112 to 142 have physical blocks PB0 to PB1023. Each physical block includes 256 pages (P0 to P255).

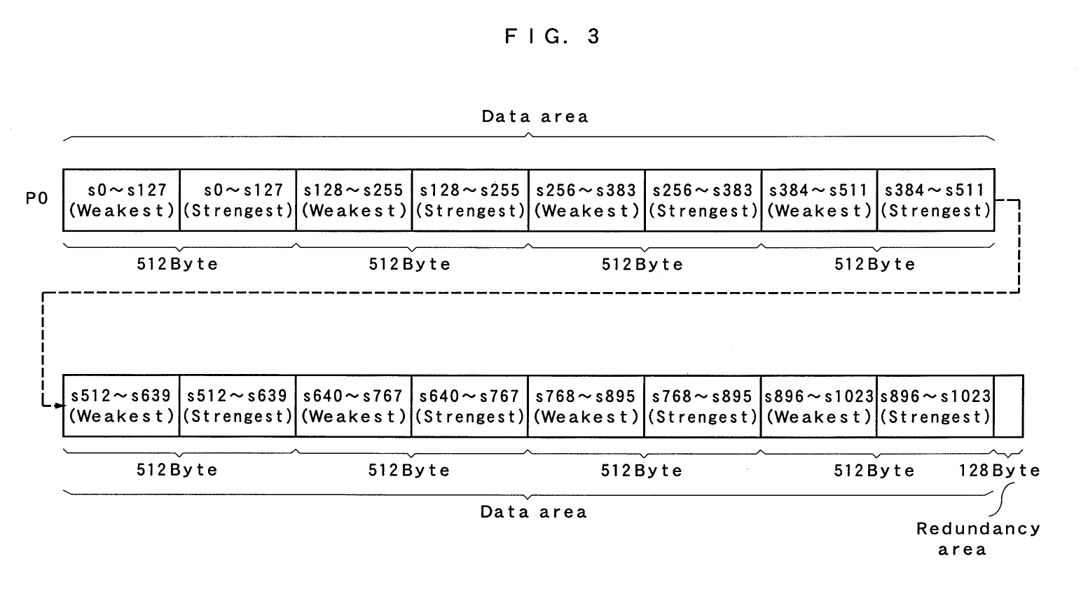

FIG. 3 is a diagram showing a record format of each page using the page P0 of the physical block PB0 as an example. Each page of all physical blocks includes a data area of 4096 Bytes and a redundant area of 128 Bytes. In the present embodiment, the data area is divided into eight sectors. Each sector has a capacity of 512 Bytes. The redundant area is not used. Detail of recorded data will be described later.

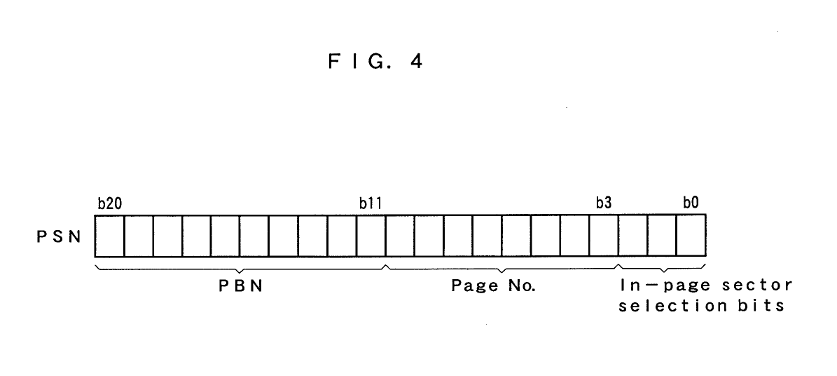

FIG. 4 is a bit format showing the physical sector number PSN. In FIG. 4, bits b0 to b2 represent in-page sector selection bits, b3 to b10 represent the page number and b11 to b20 represent the physical block number.

The in-page sector selection bits correspond to a quotient obtained by dividing the page by a sector size. In the present embodiment, in a case where the page size is 4096+128 Bytes and the sector size is 512 Bytes, that is, one page is divided into eight sectors as shown in FIG. 3, and these are selected by lower three bits of the physical address. The page size and sector size are not limited to the above-mentioned values and the in-page sector selection bits may be made variable according to the values.

The memory controller 111A to 141A each include an interface circuit, buffer or the like for converting read instructing information supplied from the access module 200A into a read command to the nonvolatile memory banks 112 to 142, respectively. The interface circuit is mounted in a commercially available memory card (for example, SD card) and thus, description thereof is omitted.

Next, each block of the access module 200A will be described in detail referring to FIG. 1B. Musical performance data is generated according to an operation such as key-touch of an external master keyboard 300 and is taken into the CPU part 230A through the input and output part 210A. The input and output part 210A includes a terminal for inputting the musical performance data from the master keyboard 300, a DA converter for digital-analog converting the musical sound generated by the signal processing part 220, an amplifying part for amplifying the converted musical sound and a line out terminal for outputting the output to the outside.

The signal processing part 220 is a block for generating the musical sound by performing interpolation and level control of the musical sound data of maximum 32 channels, which is supplied from the CPU part 230A, and then, performing effect processing such as mixing and reverb of the sounding channels. The signal processing part 220 includes a digital signal processor (hereinafter referred to as DSP), a ROM which stores program of the DSP therein a RAM necessary for a delay element for effector processing and for temporarily storage of parameters, and so on.

The CPU part 230A performs channel assign processing of the musical performance data received by the input and output part 210A and requests the read instructing part 240 to read the data from the nonvolatile storage modules 110A to 140A. The CPU part 230A also supplies the musical sound data read by the read instructing part 240 from the nonvolatile storage modules 110A to 140A and a part of the musical performance data to the signal processing part 220.

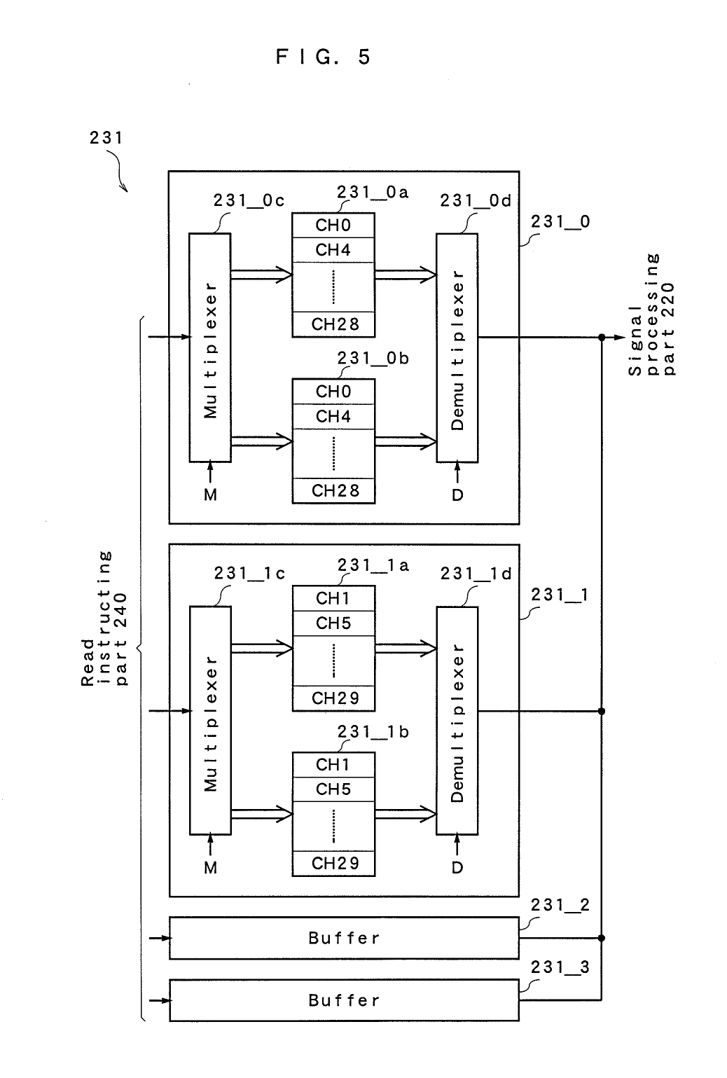

FIG. 5 is a block diagram showing the musical sound data buffer 231 contained in the CPU part 230A. The musical sound data buffer 231 includes four buffers 231_0 to 231_3. The buffers have the identical internal circuit configuration and are used differently by different sound channels as shown in the following (a) to (d).

(a) Buffer 231_0

for temporary storage of the musical sound data of CH0, 4, 8, 12, 16, 20, 24, 28

(b) Buffer 231_0

for temporary storage of the musical sound data of CH1, 5, 9, 13, 17, 21, 25, 29

(c) Buffer 231_0

for temporary storage of the musical sound data of CH2, 6, 10, 14, 18, 22, 26, 30

(d) Buffer 231_0

for temporary storage of the musical sound data of CH3, 7, 11, 15, 19, 23, 27, 31

The buffer 231_0 has dual port RAMs 231_0a, 231_0b, a multiplexer 231_0c and a demultiplexer 231_0d. The dual port RAMS 231_0a, 2310_{—}b each are a RAM of 4 kBytes for temporarily storing eight pieces of data of CH0, 4, 8 . . . 28 therein and have a storage capacity of 512 Bytes per channel. The buffer 231_1 has dual port RAMs 231_1a, 231_1b, a multiplexer 231_1c and a demultiplexer 231_1d. The dual port RAMs 231_1a, 231_1b each are a RAM of 4 kBytes for temporarily storing eight pieces of data of CH1, 5, 9 . . . 29 therein and have a storage capacity of 512 Bytes per channel. The other buffers 231_2, 231_3 have a similar configuration and are used as buffers for the above-mentioned channels.

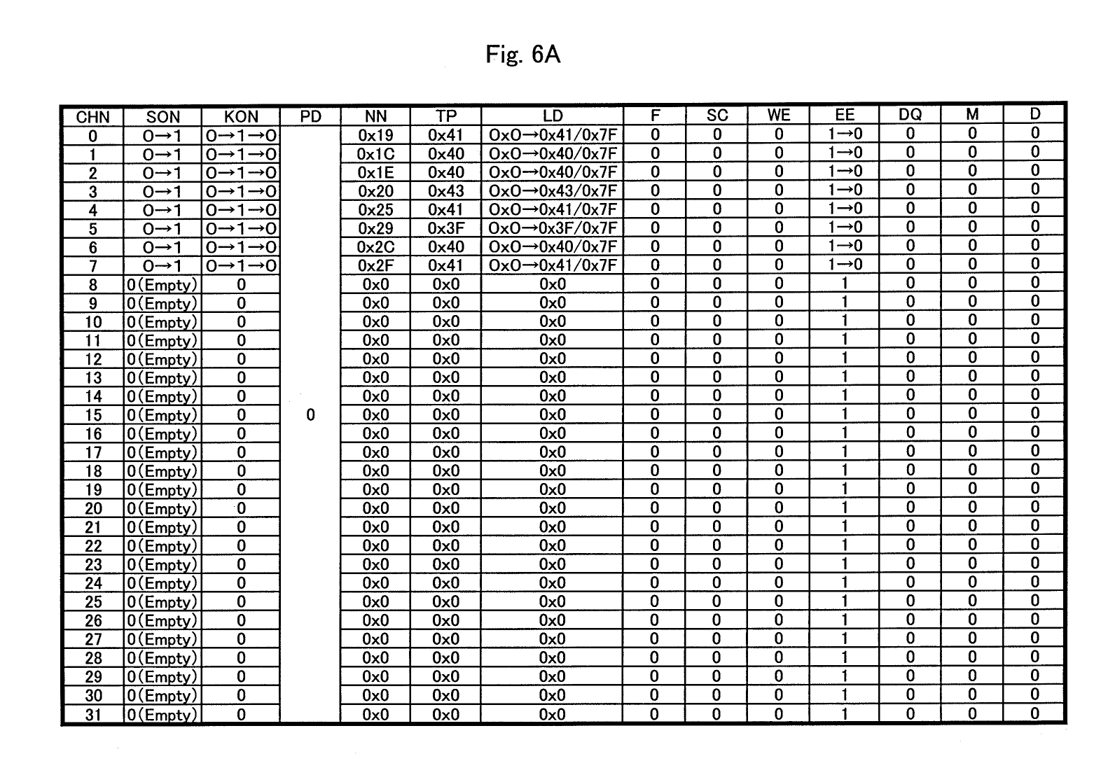

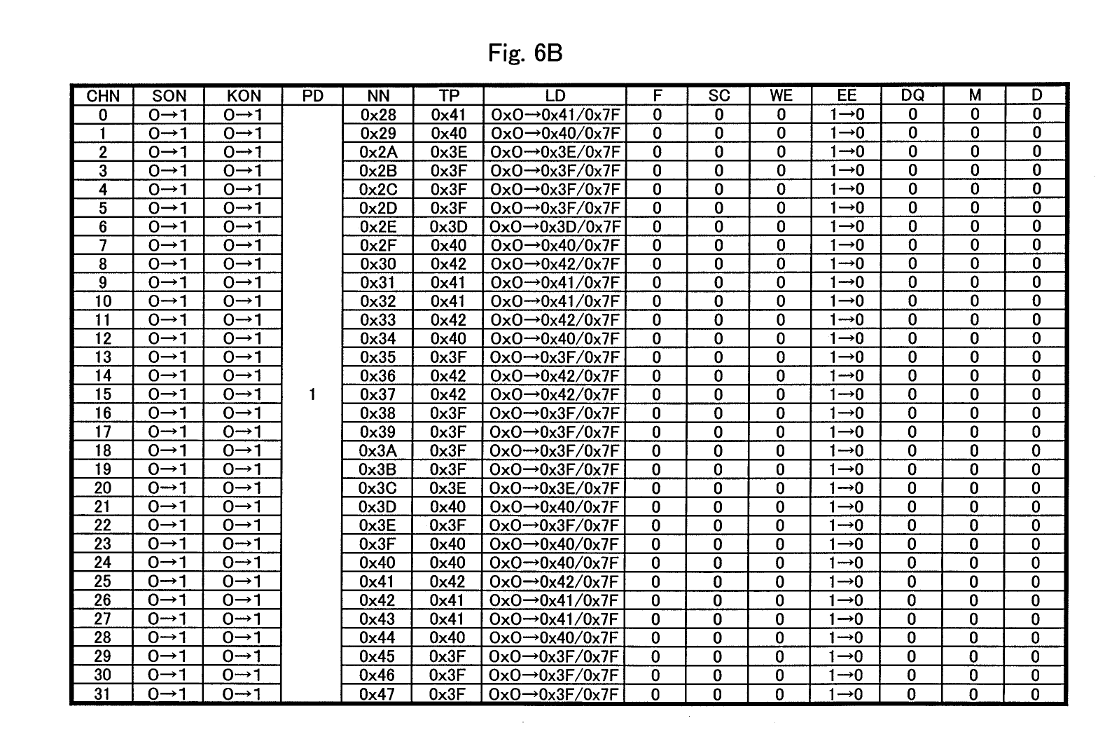

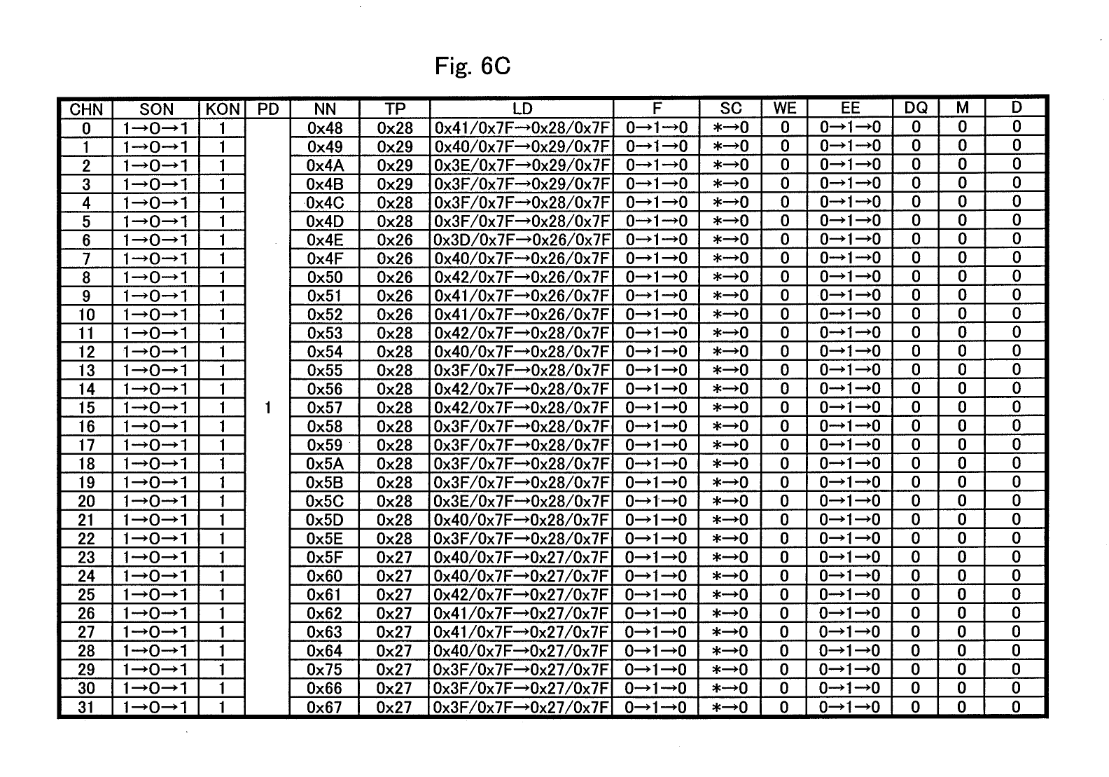

FIGS. 6A to 6C are diagrams for describing the channel assign table 232 contained in the CPU part 230A. The channel assign table 232 holds the following information representing a status such as the sounding state of all channels, that is, CH0 to CH31. The information will be described below.

A sounding flag SON is a flag representing whether or not the corresponding channel is sounding and represents that the channel is a sounding channel at a value 0 and a free channel at a value 1.

A KON flag is a flag which has the value 1 during a period from key-touch to key-release.

A note number NN is a hexadecimal number corresponding to a piano key position.

A touch parameter TP is strength and weakness information corresponding to strength of hey-touch.

Level data LD corresponds to an amount of the musical sound which is determined depending on the strength of key-touch.

A forced sound deadening flag F is a flag for forcedly deadening the musical sound.

A sector counter SC is a counter for counting up each time the musical sound data of one sector, that is, 128 samples is read.

A wave end flag WE is a flag representing that a final sample of the musical sound data, that is, s1763999 is processed for generation of the musical sound.

An envelope end flag EE is a flag set to have the value 1 when an amount of the musical sound which changes depending on a state of key-touch and a state of sustain pedal (hereinafter referred to as envelope ENV) is put into an acoustically inaudible amount level.

A musical sound data read request flag DQ is a flag set when the number of samples of the musical sound data used by the signal processing part 220 to generate the musical sound reaches a predetermined threshold value (for example, 96 samples).

A selecting flag M is a flag for selecting which the dual port RAM 231_0a or 231_0b the musical sound data is written to, in the buffer 231_0 among the musical sound data buffers 231. The same applies to the buffers 231_1 to 231_3.

A selecting flag D is a flag for selecting which the musical sound data stored in the dual port RAM 231_0a or 231_0b is transferred to the signal processing part 220 in the buffer 231_0. The same applies to the buffers 231_1 to 231_3. With respect to the buffer 231_0, the flags D and M select the dual port RAM 231_0a at the value 0 and the dual port RAM 231_0b at the value 1 in the buffer 231_0. The same applies to the buffers 231_1 to 231_3.

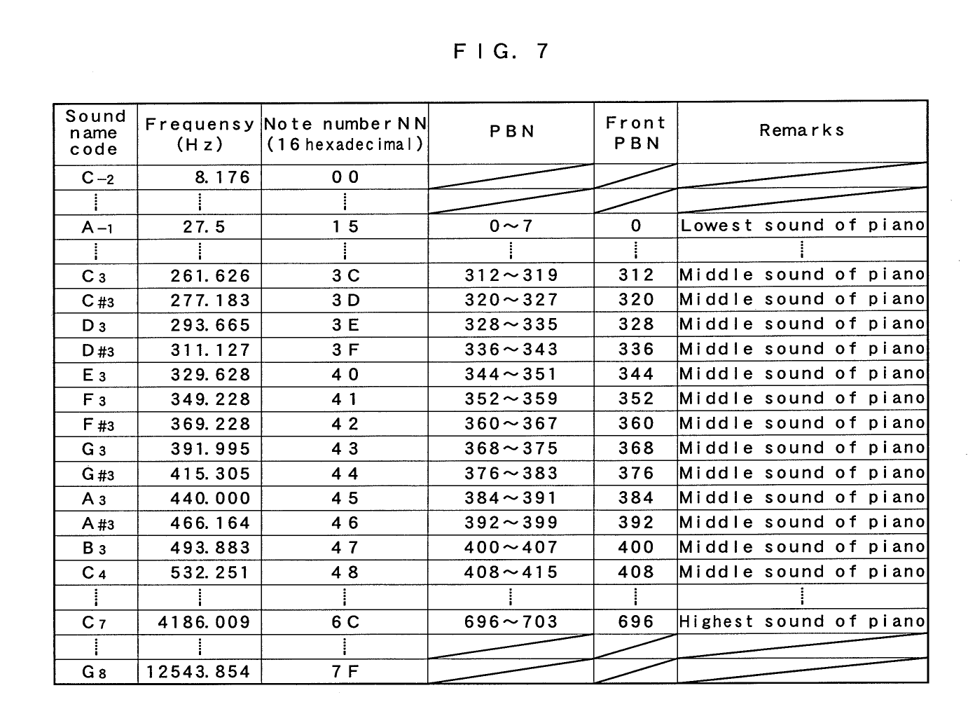

FIG. 7 is a diagram for describing the NN table 233A in the CPU part 230A. The NN table is a table representing relationship between the note number NN and a number of the physical block which stores the musical sound data corresponding to the NN therein.

The musical performance data buffer 234 is a FIFO holding a plurality of pieces of the musical performance data inputted from the master keyboard 300. The transfer monitoring part 235 in the CPU part 230A monitors data transfer and transfers a transfer completion flag TRNF to the signal processing part 220 when data is temporarily stored in an area corresponding to one of two channels of each of the buffers 231_0 to 231_3.

The read instructing part 240 is a block for transferring the read instructing information to the nonvolatile storage modules 110A to 140A according to a read request of the CPU part 230A and the access state of the nonvolatile storage modules 110A to 140A.

The read instructing part 240 includes a channel register 241 and an MM register 242.

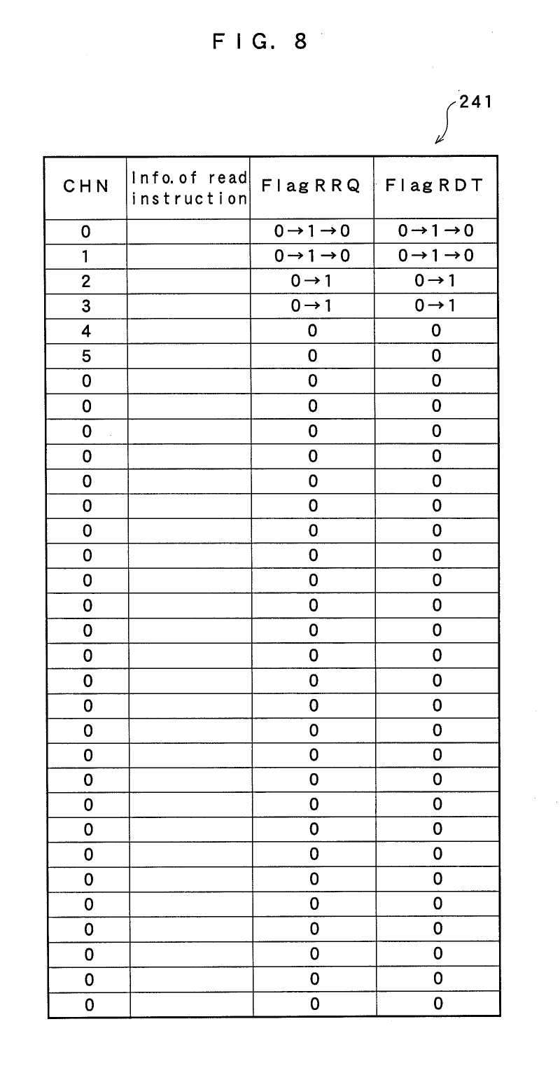

FIG. 8 is a memory map showing the channel register 241 included in the read instructing part 240. The channel register 241 is a register which represents a read instructing state of 32 channels and has read instructing information, a read request flag RRQ, a read instructing information transfer flag RDT for the 32 channels. The read request flag RRQ (hereinafter referred to as RRQ) is a flag whose value is 0 when the CPU part 230A does not issue the read request and is 1 when the CPU part 230A issues the read request. The read instructing information transfer flag RDT (hereinafter referred to as RDT) is a flag which is set when the read instructing part 240 transfers the read instructing information to any of the nonvolatile storage modules 110A to 140A and reset when there is no request.

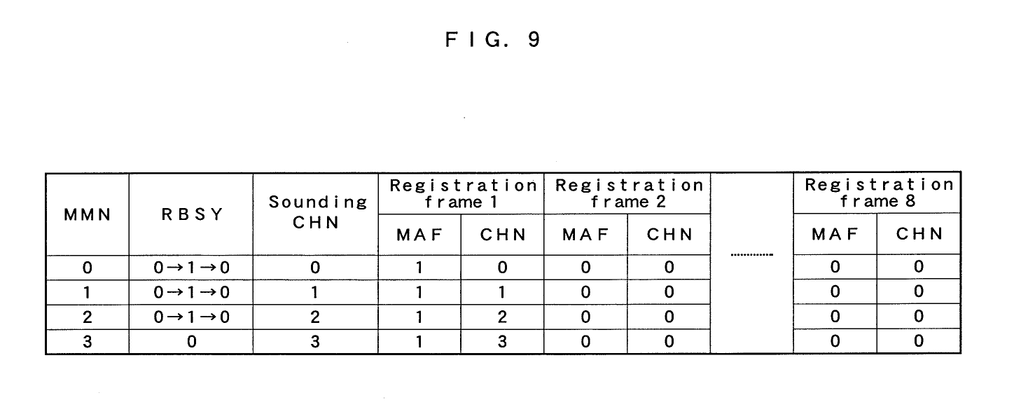

FIG. 9 is a memory map showing the MM register 242 included in the read instructing part 240. The MM register 242 is a register which represents the access state of the nonvolatile storage modules 110A to 140A and has reading flags RBSY for four nonvolatile storage modules 110A to 140A. The nonvolatile storage module 110 corresponds to MMN of 0 (hereinafter referred to as MM0), the nonvolatile storage module 120 corresponds to MMN of 1 (hereinafter referred to as MM1), the nonvolatile storage module 130 corresponds to MMN of 2 (hereinafter referred to as MM2) and the nonvolatile storage module 140 corresponds to MMN of 3 (hereinafter referred to as MM3). The value of the reading flag RBSY (hereinafter referred to as RBSY) is set to 1 when the read instructing part 240 transfers the read instructing information to the nonvolatile storage modules 110A to 140A and reset to 0 when data corresponding to the read instructing information (512 Bytes) is read from the nonvolatile storage modules 110A to 140A.

The MM register 242 includes eight registration frames 1 to 8 in each of the nonvolatile storage modules MM0 to MM3 and each of the registration frames 1 to 8 includes an MAF and CHN. The MAF represents a module assign flag and when a value of the flag is 1, the read instructing information is transferred to the corresponding nonvolatile storage module and sound is produced. The value of MAF is reset to 0 when sounding of the corresponding channel is completed. The CHN represents a sounding channel number. The nonvolatile storage modules 110A to 140A each can accept the read instructing information of maximum eight channels.

### [Initial State]

First, details of initialization performed on the manufacturer's side prior to shipment of the storage module 100A or musical sound generating system shown in FIGS. 1A and 1B will be described. In the present embodiment, in the case where piano musical sound data is digitally recorded with at a sampling frequency of 44.1 kHz, the musical sound data for about 40 seconds for each pitch is recorded in each of the nonvolatile memory banks 112 to 142 in a non-compressed form. It is assumed that the time taken from touch of a piano key to sufficient sound attenuation is 40 seconds. In this case, 1764000 samples are obtained as represented by a formula (4).

44.1 kHz×40 seconds=1764000 samples (4)

Here, with respect to two kinds of data: a strongest touch and weakest touch, as shown in FIG. 2, the previously digitally-recorded piano musical sound data of 88 keys extending from the lowest sound to highest sound of a piano is written to the physical blocks PB0 to PB703 of the nonvolatile memory bank 112 in ascending order. The same data is similarly written to each of the nonvolatile memory banks 122 to 142. Thereby, the same data is multiplexed and recorded in the four parallel nonvolatile memory banks.

Data of the lowest piano sound is recorded in PB0 to PB7 of each memory bank and the musical sound data of 1764000 samples from a forefront sample (s0) to a rearmost sample (s1763999) immediately after key-touch is recorded in the memory banks from P0 of PB0 in ascending order. As shown in FIG. 3, the two kinds of musical sound data: the weakest touch and strongest touch forming a pair is written in units of 512 Bytes.

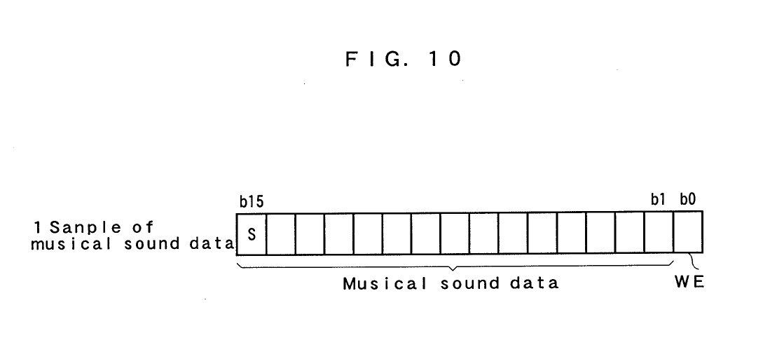

FIG. 10 is a bit format showing one sample of the musical sound data. In FIG. 10, a sign bit representing positive and negative is written to b15 and 15 bits from b15 to b1 are used as one sample of the musical sound data. The wave end flag WE is recorded in b0. The flag WE is a flag representing whether or not the corresponding sample is a final sample and when the value of the flag is 1, the corresponding sample is defined as a final sample.

Furthermore, at initialization, characteristic information of the piano musical sound data recorded in the storage module 100A (hereinafter referred to as recorded data characteristic information) and information on a memory configuration of the storage module 100A (hereinafter referred to as memory structure information) are written to the page P0 of the final physical block PB1023 of the nonvolatile memory bank 112.

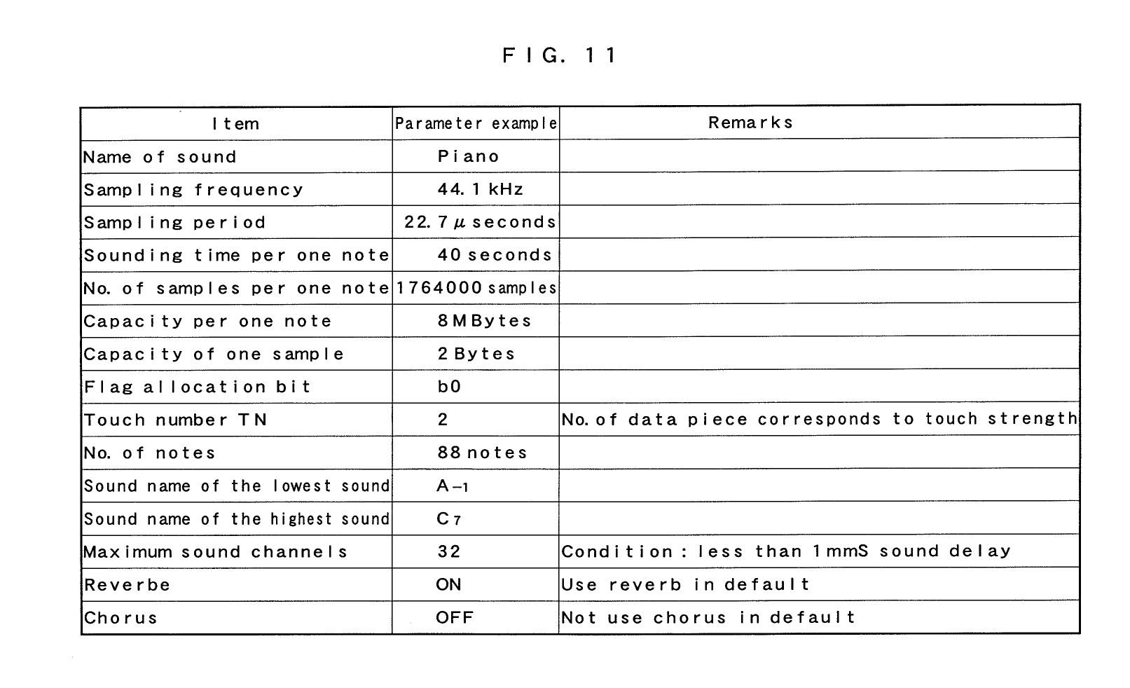

FIG. 11 is an explanatory diagram showing an example of the recorded data characteristic information. The characteristic information includes at least information on the sampling frequency of the musical sound data (in this case, 44.1 kHz). Reverb and chorus are used in effect processing. In the table of FIG. 11, information in remarks column is not actually recorded information but reference information.

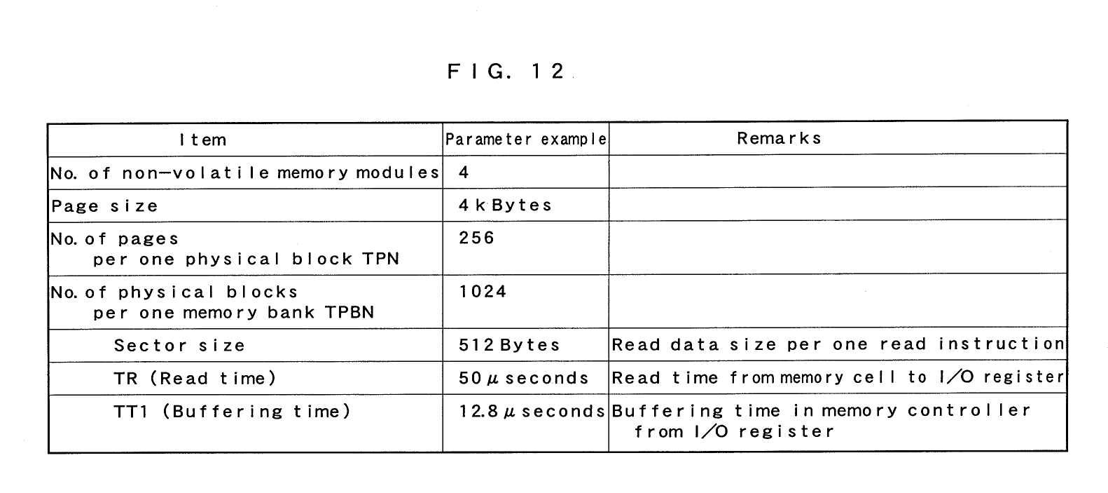

FIG. 12 is an explanatory diagram showing an example of the memory structure information of the storage module 100A. In FIG. 12, the sector size represents a size of data read according to one read instruction and the read time TR represents a read time from the memory cell array to the I/O register. A transfer time TT1 represents a time for buffering in the memory controller from the I/O register of each memory bank. In the table of FIG. 12, information in remarks column is not actually recorded information but reference information.

Operation of the musical sound generating system thus configured according to the first embodiment of the present invention will be described.

[Initializing Processing at Power-On]

After power-on of the access module 200A and storage module 100A, initializing processing of each module starts. The respective memory controller performs initializing processing of the storage module 100A and when initialization finishes, an access to the access module 200A is permitted. The initializing processing of the memory controller is commonly known and thus description thereof is omitted.

The access module 200A performs its initializing processing separately in the CPU part 230A and read instructing part 240.

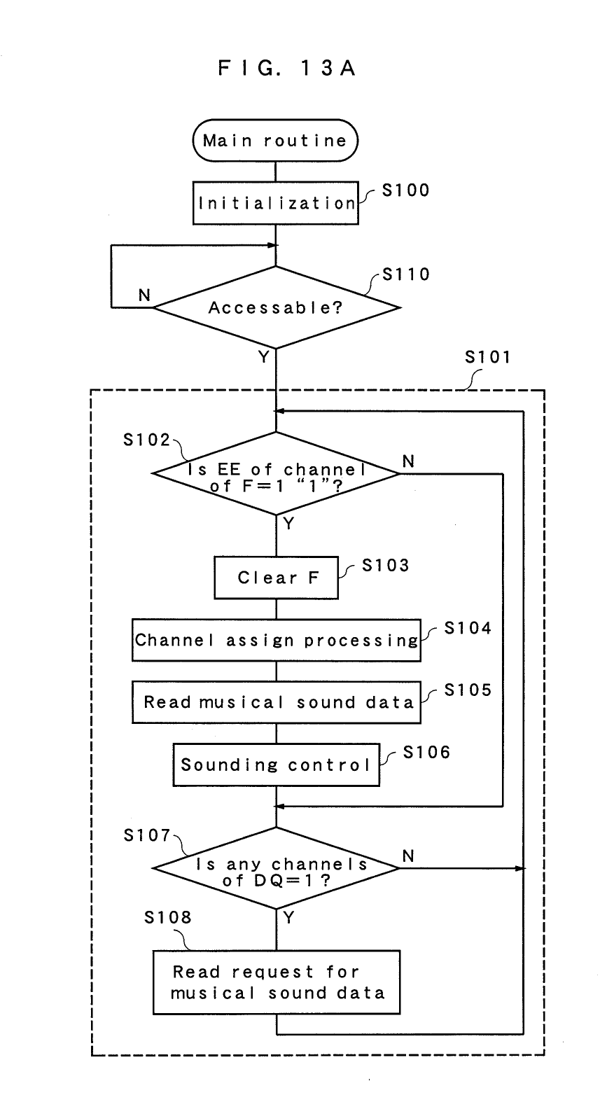

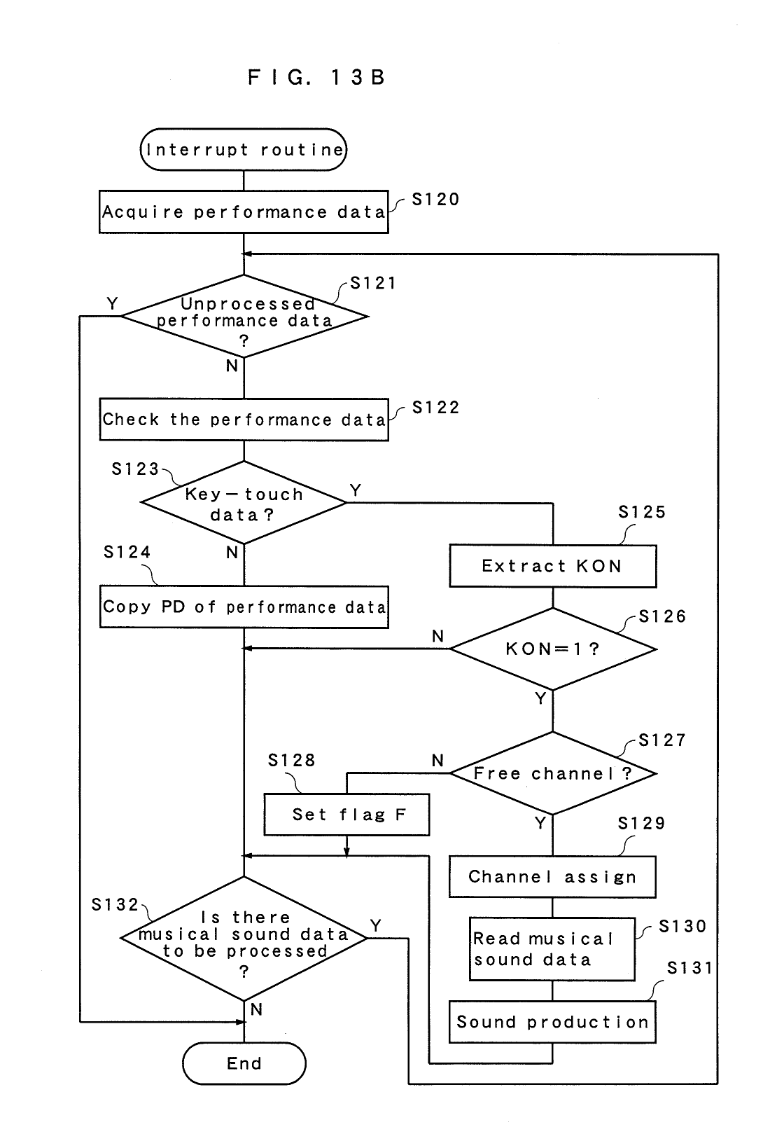

The CPU part 230A of the access module 200A performs initializing processing at S100 as shown in a flowchart of FIG. 13A. In the initializing processing, the signal processing part 220 is reset and each of the dual port RAMs of the buffers 231_0 to 231_3 in the musical sound data buffer 231 is cleared. By resetting the signal processing part 220, the signal processing part 220 starts count-up of an internal program counter of the DSP. Furthermore, initialization of the channel assign table 232 shown in FIG. 6A to FIG. 6C, that is, the following processing is performed.

(1) A value of the SON is set to 0, that is, CH0 to 31 are set to free channels.

(2) Each of the values of the KON, PD, NN, TP, LD, F, SC, WE, DQ, M, D is set to 0.

(3) The value of the EE is set to 1

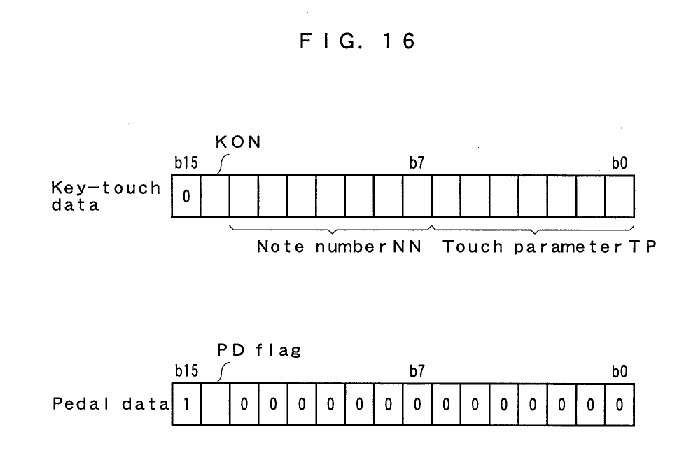

After that, the access module 200A transfers the read instructing information of the recorded data characteristic information and memory structure information to the nonvolatile storage module 110A. FIG. 15 is a bit format showing the read instructing information transferred from the access module 200A to the nonvolatile storage module 110. b22 and b21 are provided so as to attend instructions other than read instruction, but since the instructions other than the read instruction are not issued in the present embodiment, the values of b22 and b21 are fixed to 11. The characteristic information is written to the nonvolatile memory bank 112 of 512 Bytes or less from an address 0 of P0 of PB1023. The access module 200A transfers the read instructing information to the nonvolatile storage module 110, thereby reading the recorded data characteristic information and memory structure information.

When obtaining the recorded data characteristic information shown in FIG. 11, the CPU part 230A sets a sampling cycle (22.7 μs) in a timer in the signal processing part 220 and determines one cycle of a time slot of one sampling time in the signal processing. This timer functions as a timer for controlling one cycle of the DSP in the signal processing part 220. The CPU part 230A writes one sample capacity (2 Bytes) in the recorded data characteristic information and flag allocating bit (b0) as parameters of the RAM in the signal processing part 220 and uses the parameters as parameters for determining the bit position in the bit format shown in FIG. 10 to which the musical sound data corresponds.

The CPU part 230A also determines a channel framework of the channel assign table 232 based on the maximum number of sounding channels (32 CH) in the recorded data characteristic information and determines the number of channels in the time slot of the signal processing part 220. The signal processing part 220 determines the effect processing such as reverb and chorus. In the shown example, it is determined that only reverb is performed as the effect processing.

When obtaining the memory structure information shown in FIG. 12, the CPU part 230A finds a parallel number by calculating a formula (5) based on the number of the nonvolatile storage modules.

Parallel number=the number of nonvolatile storage module (5)

The maximum number of channels which are assigned to one nonvolatile storage module, that is, to which the read instructing information is transferred (maximum number of channels per module) is calculated according to a formula (6). Where, % is a modulus operator.

Maximum number of channels per module=CHN % parallel number (6)

In the present embodiment, since the CHN is 32 and the parallel number is 4, according to the formula (6), each of the nonvolatile storage modules 110A to 140A can assign the read instructing information of the maximum eight channels. It will be described later which nonvolatile storage module each channel is assigned to.

The CPU part 230A refers to the sector size (512 Bytes) in the memory structure information shown in FIG. 12 and manages the size of a data read unit by which data is read from the storage module 100A as 512 Bytes. The CPU part 230A also determines the total sample number for each sector (hereinafter referred to as usn) according to a formula (7).

usn=sector size/size of one sample/the number of touches (7)

In the present embodiment, since the sector size is 512 Bytes, the size of one sample is 2 Bytes and the number of touches is 2, usn becomes 128 samples.

The CPU part 230A also calculates the number of necessary physical blocks per note according to a formula (8) based on occupied capacity per note in the recorded data characteristic information shown in FIG. 11, the page size in the memory structure information and the number of pages per physical block TPN (in this case, 256).

The number of necessary physical blocks per note=occupied capacity per note/(page size×TPN)=8 (8)

Then, the PBN corresponding to each note from the lowest sound A₋₁ to highest sound C₇ is determined to generate the NN table 233A shown in FIG. 7.

In the above-mentioned main routine, the CPU part 230A finishes the initializing processing (S100) by reading the recorded data characteristic information and memory structure information and setting various parameters.

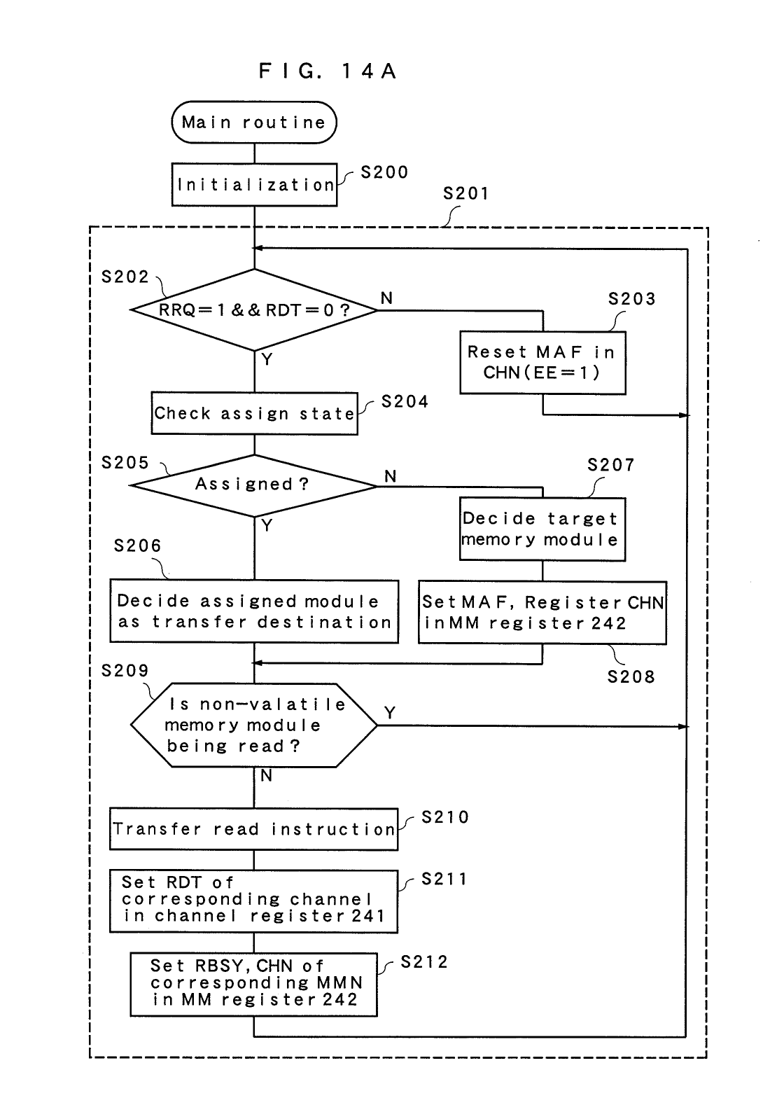

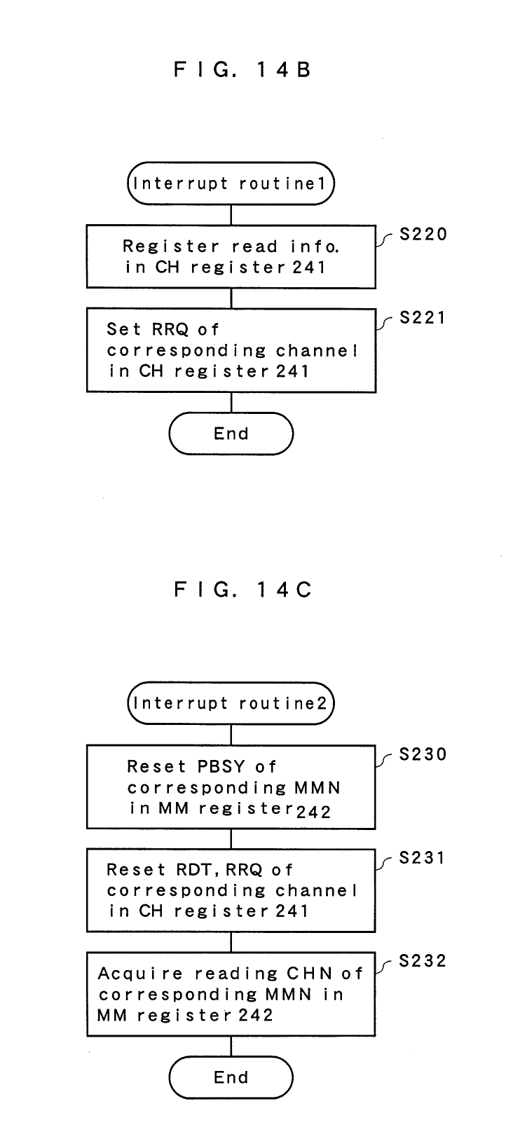

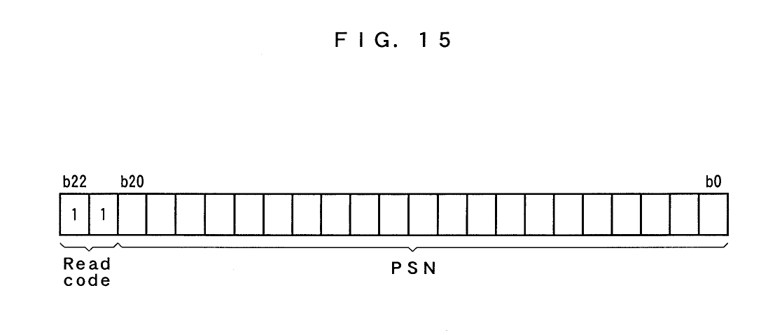

FIG. 14A is a flow chart showing normal processing of the read instructing part 240 and FIGS. 14B and 14C are flow charts showing interrupt processes.

As shown in the flow chart of FIG. 14A, the read instructing part 240 performs initializing processing at S200. In the initializing processing, when receiving access permission from all of the nonvolatile storage modules of the storage module 100A, the read instructing part 240 notifies the CPU part 230A of accessibility.

When receiving notification of accessibility from the read instructing part 240, the CPU part 230A shifts from S110 to normal operation processing S101, enables interrupt and accepts the musical performance data from the external master keyboard 300.

### [Normal Operation Processing]

(1) Description of Overall Operation

Overall operation from inputting of the musical performance data to generation of the musical sound will be described referring to mainly the flow chart of the CPU part 230A and flow chart of the read instructing part 240. It is noted that the flow chart of the CPU part 230A and flow chart of the read instructing part 240 are separately performed.

FIG. 13B shows an interrupt routine of the CPU part 230A and the interrupt routine is started when the musical performance data is transferred to the access module 200A according to a performing operation of the master keyboard 300. When the performing operation of the master keyboard 300 is made during the main routine shown in FIG. 13A, the main routine is immediately shifted to the interrupt routine. It is assumed that the interrupt routine enables multiple interrupt, in other words, the next interrupt can be accepted even in the interrupt routine.

Meanwhile, in the flow chart of the read instructing part 240, the interrupt routine includes an interrupt routine 1 shown in FIG. 14B and interrupt routine 2 shown in FIG. 14C, no priorities are assigned and both routines enable multiple interrupt. The interrupt routine 1 is started when the read request is made from the CPU part 230A and the interrupt routine 2 is started when the musical sound data is received from the storage module 100A.

First, when the performing operation of the master keyboard 300 is not made after shift to the normal operation processing S101, since a value of the forced sound deadening flags F of all channels is 0 and a value of the read request flag DQ is 0, S102 and S107 branch to No and branch processing at S102 and S107 are permanently performed.

When the performing operation of the master keyboard 300 is made, the interrupt routine shown in FIG. 13B is started. This interrupt processing will be described.

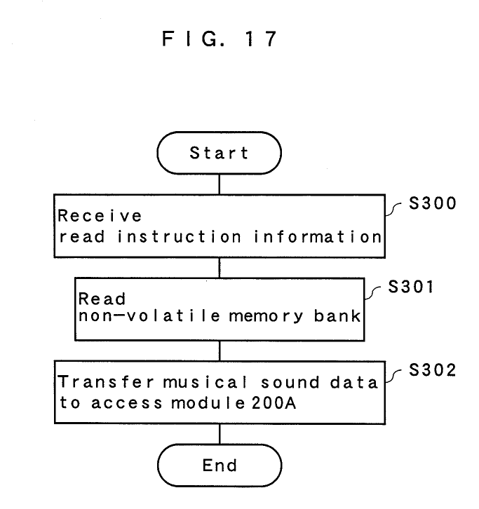

FIG. 16 is a bit format showing the musical performance data transferred from the master keyboard 300. The musical performance data is classified into two kinds of data: key-touch data generated according to key-touch and pedal data generated according to an ON/OFF operation of the sustain pedal. The data is identified by the value of b15. In the key-touch data, the KON flag, note number NN and touch parameter TP are abovementioned. In the pedal data, the value of a flag PD becomes 1 when the sustain pedal is turned ON. The sustain pedal is a pedal for keeping sound even when the key is released, which is provided at the actual piano. In the interrupt routine, first, the musical performance data transferred from the master keyboard 300 through the input and output part 210A is acquired in the musical performance data buffer 234 (S120). The format of the musical performance data is, as shown in FIG. 16, the key-touch data or pedal data. When there is no unprocessed musical performance data already acquired (S121), the musical performance data buffer 234 checks the musical performance data acquired this time (S122). Specifically, the musical performance data buffer 234 identifies whether the musical performance data is the key-touch data or pedal data by examining b15 of the musical performance data shown in FIG. 16. In a case where the musical performance data is the pedal data (S123), b14 in the pedal data shown in FIG. 16, that is, the PD flag is copied to the PD in the channel assign table 232 as it is (S124), the procedure proceed to S132. When the musical performance data is the key-touch data (S123), the KON flag is extracted from b14 of the key-touch data shown in FIG. 16 (S125) and the value of the KON is checked at S126, and when the value of the KON is 0 meaning key-release, the procedure proceeds to S132.

In a case where the value of the KON is 1, that is key-touch, it is examined whether or not there is a free channel in the channel assign table 232 (S127). Specifically, it is examined whether or not there is the sounding flag SON having the value 0 from the CH0 in ascending order, and when there is the sounding flag SON, the musical performance data is assigned to a channel found firstly (S129). In the channel assign processing, information of the channel to which the data is assigned is set as follows.

(1) The value of the SON is set to 1.

(2) The NN and TP are copied from the key-touch data.

(3) The values of the SC, WE, EE, DQ, M, D are set to 0.

After the channel assign processing, the CPU part 230A sends the read request along with the read instructing information of the musical sound data shown in FIG. 15 to the read instructing part 240. The read instructing information is found according to the following procedures.

(a) The NN table 233A is referred based on NN of the key-touch data to find a front PBN.

(b) The PSN is found according to a formula (9) based on the front PBN and SC.

PSN=(front PBN<<11)+SC (9)

Where, & is an operator for obtaining a logical AND, | is an operator for obtaining a logical OR and << is an operator for bit shift to the left.

(c) The PSN found according to the formula (9) has 21 bits and the upper two bits are “11”. Accordingly, the read instructing information is found according to a following formula (10). Where, “0x” is a sign representing the hexadecimal number. FIG. 15 shows the read instructing information.

Read instructing information=0x600000|PSN (10)

In this manner, the CPU part 230A determines the PSN of a read destination and sends the read instructing information in the format shown in FIG. 15 to the read instructing part 240. When receiving the CHN and read instructing information which correspond to the read request, the read instructing part 240 registers the received CHN and read instructing information in the channel register 241. After that, the read instructing part 240 determines the nonvolatile storage module as a target for reading based on the MM register 242. Then, if the musical sound data is being read, the read instructing part 240 transfers the read instructing information registered in the channel register 241 to the nonvolatile storage module and reads desired musical sound data.

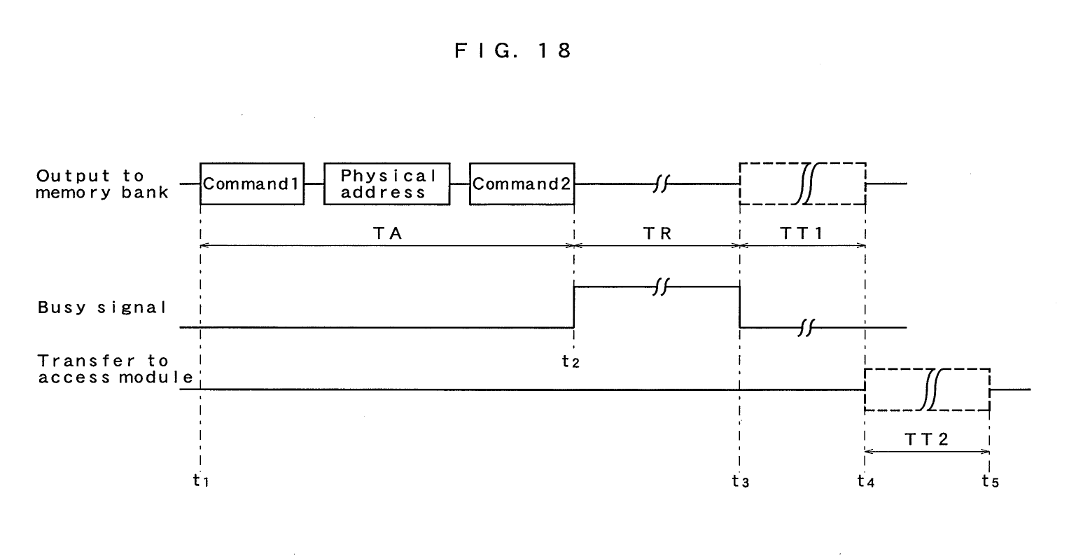

Next, reading of the musical sound data from the storage module 100A by the read instructing part 240 will be described referring to mainly the flow charts of FIGS. 14A to 14C and 17. First, in the main routine shown in FIG. 14A, the read instructing part 240 shifts to the normal processing (S201) after the above-mentioned initializing processing (S200). While the CPU part 230A does not issue the read request, values of the PRQ in the channel register 241 are 0 and in this case, the read instructing part 240 monitors change of EE managed by the CPU part 230A and operates the flags of the MM register 242 according to the monitoring result (S203). Specifically, for the channels with the MAF having the value 1 in the MM register 242, when the value of the EE changes from 0 to 1, that is, from the sounding state to the silent state, the value of the MAF of the channel is reset to 0 and the channel is excluded from the registration frame. Subsequently, the procedure returns to S202 and thereafter, branch processing at S202 and S203 are permanently performed.

Then, when receiving the read request from the CPU part 230A, the read instructing part 240 shifts from a loop of S202 and S203 in the main routine to the interrupt routine 1 shown in FIG. 14B, registers the read instructing information in the channel register 241 and the CHN transferred together with the read instructing information in a CHN column of the channel register 241 (S220). Furthermore, the read instructing part 240 sets the value of the RRQ corresponding to the above-mentioned CHN to 1 (S221), finishes interrupt and returns to the main routine. In the example shown in FIG. 8, the read request of CH0 to 3 is made from the CPU part 230A and the value of each flag changes according to processing described later. Specifically, the example shows the period until when transfer of the read request of CH0 to 3 and read instructing information to the nonvolatile storage modules 110A to 140A is completed and transfer of the musical sound data from the nonvolatile storage modules 110A, 120A to the access module 200A is completed. By the operation, a value of each flag in the channel register 241 changes. Also in the MM register 242 (FIG. 9), the value of the flag RBSY representing whether or not each of the nonvolatile storage modules (MM0 to MM3) is being read changes.

In the main routine shown in FIG. 14A, since the value of the RRQ of CH0 to 3 becomes 1, the procedure proceeds from S202 to S204 and the read instructing part 240 checks the assign status, that is, whether or not the read instructing information corresponding to CH0 to 3 is assigned (transferred) to the nonvolatile storage module based on the MM register 242. Specifically, at S205, the read instructing part 240 checks the registration frames 1 to 8 and when the CHN with the MAF having a value 1 is any of CH0 to 3, determines that the read instructing information is assigned. Then, the read instructing part 240 determines the nonvolatile storage memory module in which the CHN with the MAF having the value 1 is any of CH0 to 3 as a transfer destination of the read instructing information (S206).

On the other hand, when the read instructing information is not assigned, at S207, the number of registration frames with the MAF having a value 1 in the MM register 242 (the number of registrations) is counted and the nonvolatile storage module with a smallest number of registrations is determined as the transfer destination of the read instructing information. When there are a plurality of nonvolatile storage modules with the smallest number of registrations, the nonvolatile storage module having a smaller nonvolatile storage module number is preferentially selected. After that, in the nonvolatile storage module determined as the transfer destination of the read instructing information, any MAF having a value 0 in the registration frames is set to have a value 1 and the value of the CHN as an assign target is registered in a corresponding CHN column (S207). Since the MM register 242 is initially in a non-registered state, CH0 to 3 are registered in the registration frame 1 of MM0 to 3, respectively, as shown in FIG. 9.

Next, referring to the reading flag RBSY in the MM register 242, the read instructing part 240 determines whether or not any of the nonvolatile storage modules 110A to 140A is being read (S209). Since all of the value of the RBSY in the MM register 242 is initially 0, that is, the nonvolatile storage module 110A to 140A are not being read, the procedure first proceeds to S210 in processing of CH0.

Then, the read instructing part 240 transfers the read instruction corresponding to CH0 to the nonvolatile storage module 110 (S210) and sets the value of the RDT of the channel corresponding to the channel register 241 to 1 (S211). Furthermore, the read instructing part 240 sets the value of the RBSY of the storage module (MM0) corresponding to the MM register 242 to 1 and sets 0 in the reading CHN column of MM0 (S212). This shows that the musical sound data of CH0 is being read from the nonvolatile storage module 110.

The above-mentioned processing is performed for the channels with the PRQ having the value 1 in the channel register 241, that is, CH0 to 3.

FIG. 17 is a flow chart showing processing of each memory controller. When receiving the read instructing information (S300), the memory controller sets the PSN included in the read instructing information as a reading address and outputs the read command to the nonvolatile memory bank (S301). The resultant read musical sound data is transferred to the access module 200A (S302).

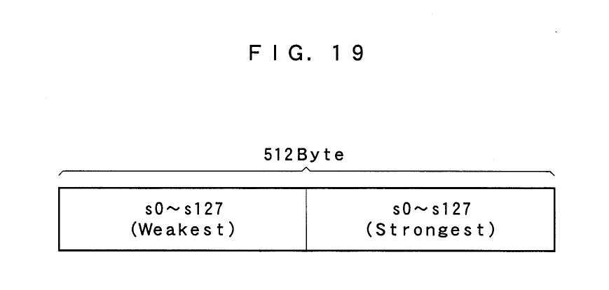

FIG. 18 is a time chart showing the read command issued to the nonvolatile memory bank by the memory controller. A command 1 is a command to notify start of transfer of a physical address and a command 2 is a command to instruct the I/O register to read the musical sound data stored at the physical address from the memory cell array.

Here, as shown in FIG. 18, according to the read command, the physical address is outputted at time t1 immediately after outputting of the command 1 and then, the command 2 is outputted. An addressing time TA is about a few hundreds nanoseconds and thus, may be ignored in terms of time.

The physical address in FIG. 18 is a physical address designated in units of 512 Bytes based on the PBN, page number and in-page sector selection bits in FIG. 4. The physical address designates a start address (byte unit) at which the target musical sound data is stored and the musical sound data stored from the start address to a final address in the corresponding page is read to the corresponding I/O register in the TR. After that, by giving 512 read clocks during the transfer time TT1, the desired musical sound data of 512 Bytes is read from the I/O register to the memory controller.

When the read instructing part 240 finishes issuing of the read instructing information corresponding to CH0 to 3 to the nonvolatile storage modules 110A to 140A, respectively, the value of the RDT of CH0 to 3 becomes 0. Accordingly, in FIG. 14A, the loop of determination branch processing at S202 and S203 is repeated again.

The access module 200A temporarily stores the transferred musical sound data in the musical sound data buffer 231 through the read instructing part 240. At this time, when detecting the reception of the musical sound data of 512 Bytes (one sector), the read instructing part 240 shifts its control to the interrupt routine 2 in FIG. 14C, resets the value of the RBSY of the corresponding MMN in the MM register 242 to 0 (S230) and further resets the values of the RDT and RRQ of the corresponding CHN in the channel register 241 to 0 (S231). Furthermore, the read instructing part 240 acquires the reading CHN of the corresponding MMN in the MM register 242 (S232) and determines the buffer in the musical sound data buffer 231, in which the received musical sound data is stored.

Areas in the channel register 241 where the value of the RRQ is 0 are areas freed as areas for the next new read instructing information. When the value of the RRQ is 0, the value of the RDT also becomes 0 at S231 and the value of the RBSY in the MM register 242 also becomes 0 at S230. For registration of the read instructing information in the channel register 241, the areas are used from a top area to a bottom area in order and the bottom area is returned to the top area. In other words, the areas are cyclically used.

When receiving the musical sound data from any of the nonvolatile storage modules, the access module 200A temporarily stores the musical sound data in the area of the musical sound data buffer 231 which corresponds to the CHN added to the musical sound data.

Next, a transfer time TT2 for transfer of the musical sound data from the memory controller to the musical sound data buffer 231 will be described. The value of the TT2 is a parameter determined depending on the specification of the access module 200A and depends on the frequency of a clock (not shown) sent by the access module 200A to the storage module 100A through an external bus. In the present embodiment, it is assumed that the bus width of the external bus connecting the access module 200A to each of the nonvolatile storage modules 110A to 140A is 1 Byte and the data is transferred at a transfer frequency of 40 MHz. In this case, the transfer time TT2 is about 12.8 μseconds according to formula (11).

512 Bytes×(25 nS/Bytes)=12.8 μseconds (11)

In response to transfer of the read instructing information, the musical sound data read from any of the nonvolatile storage modules 110A to 140A is transferred to the CPU part 230A through the read instructing part 240. Here, it is assumed that the data is read from the nonvolatile storage module 110A. FIG. 19 is a bit format showing the musical sound data read from the nonvolatile storage module 110A onto the external bus. As represented, the bit format includes the musical sound data of the weakest touch and strongest touch. The CPU part 230A transfers the musical sound data to the buffer 2310 of the musical sound data buffer 231 and temporarily stores the data in an area corresponding to CH0 of the dual port RAM 231_0a through the multiplexer 231_0c (M=0) in FIG. 5. In temporary storing the musical sound data, selection of the buffers 231_0 to 231_3 or selection of storage area in the dual port RAM in each buffer is made depending on the CHN registered in the MM register 242 described later.

When all samples of a leading sector, that is, 512 Bytes from s0 to S127 for each of the weakest touch and strongest touch, are temporarily stored in the area corresponding to CH0 of the dual port RAM 231_0a, the transfer monitoring part 235 of the CPU part 230A transfers the transfer completion flag TRNF to the signal processing part 220. Processing after S130 by the CPU part and transfer (including monitoring of transfer) of the musical sound data to the musical sound data buffer 231 are performed in parallel.

After S130, sound is produced by the signal processing part 220 (S131). In control of sounding, the level data LD is calculated according to a calculation of TP/0x7F, the calculated LD is set as the LD in the channel assign table 232 and the KON extracted at S125 is set as the KON in the channel assign table 232. 0x7F represents a maximum value of the TP. In other words, the level data LD takes a value in a range of 0 to 1 depending on the touch parameter TP. Operation of the signal processing part 220 will be described later.

When there is no free channel at S127, that is, all value of the SON in the channel assign table 232 is 1, the value of the forced sound deadening flag F in the channel assign table 232 is set to 1 (S128) and the procedure proceeds to S132.

After that, it is checked whether or not there is musical sound data to be processed next (S132), and when there is the musical sound data, the procedure returns to S121. Since processing of the previous musical performance data has been completed at S121, the procedure unconditionally proceeds to processing after S122. On the contrary, when there is no musical sound data to be processed next at S132, the interrupt routine is finished. In this case, the CPU part returns to the main routine and resumes the processing performed when it shifts to the interrupt routine.

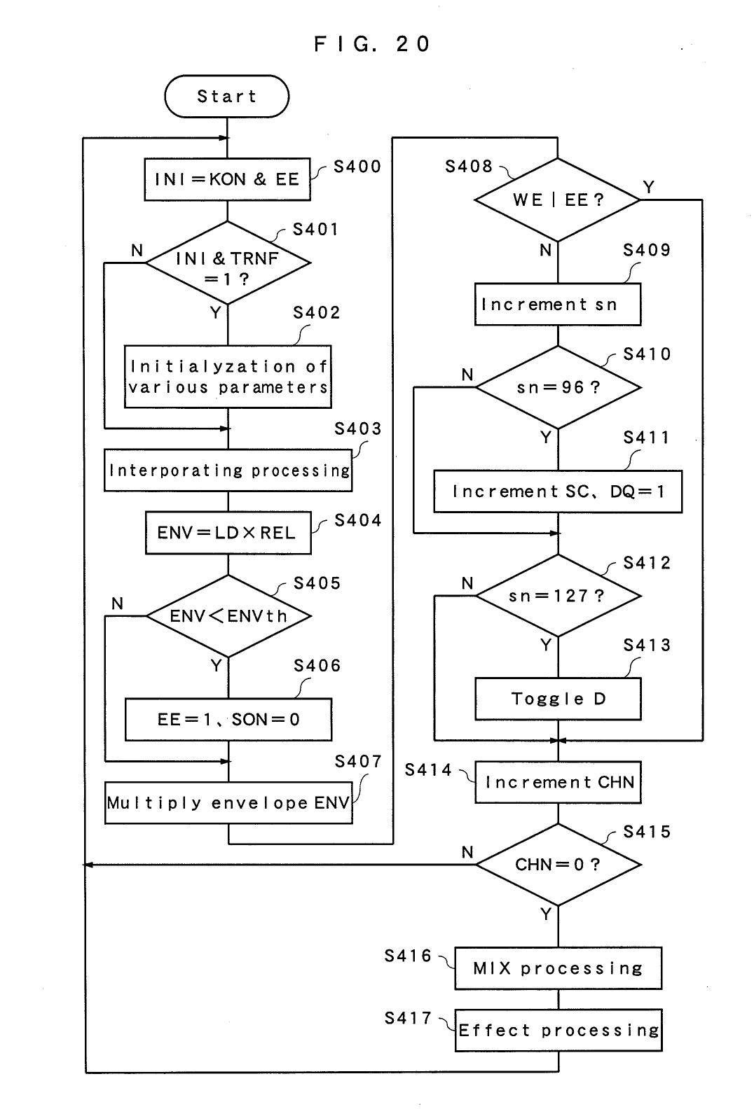

Next, the operation of the signal processing part 220 will be described referring to mainly a flow chart of FIG. 20. First, at S400, an initial flag INI is set according to a formula (12).

INI=KON&EE (12)

Here, a reason for using the EE as a calculating factor of the INI in the formula (12) is described. As described later, in a state where all channels are sounding (a value of the EE is 0), when a new key is touched, in order to prevent noise, it is need to start sounding corresponding to the new key-touch after rapid sound deadening of the channel corresponding to the new key-touch is performed, that is, the value of the EE becomes 1 and the value of the SON becomes 0.

However, to shorten a delay time from the new key-touch to start of sounding, it is need to instruct the rapid sound deadening, and simultaneously perform the channel assign processing corresponding to the new key-touch (S129) and issue the musical sound data read instruction (S130). However, immediately before the new key-touch, if the value of the KON of at least the channel to which the new key-touch is assigned is 1, the value of the KON of the channel corresponding to address the new key-touch does not become 0, that is, the value remain to be 1. In this case, new sounding control is performed following the rapid sound deadening. In this case, since the KON cannot be used as a factor for determining a sounding start time, the EE is used as the calculating factor of the INI in the formula (12). It is noted that the formula (12) can be applied any case in addition to the above-mentioned operation.

Next, at S401, the signal processing part determines the INI and TRNF. When the transfer completion flag TRNF is transferred from the CPU part 230A to the RAM in the signal processing part 220, the values of both the INI and TRNF are 1 and thus, the procedure proceeds to S402 and the signal processing part initializes various parameters. In initialization of the parameters, the value of the sn held in the counter in the signal processing part 220 is set to 0 and the value of the transfer completion flag TRNF held in the RAM in the signal processing part 220 is set to 0.

After S401 or S402, the signal processing part performs interpolating processing (S403). The interpolating processing is processing for changing tone of the musical sound depending on the strength of key-touch, that is, the value of the touch parameter TP. Generally, it is known that the tone at strong key-touch has more high-frequency components than the tone at weak key-touch. Then, in the present embodiment, by linearly interpolation between two points: the musical sound data of the strongest touch representative of the tone at strong key-touch and musical sound data of the weakest touch representative of the tone at weak key-touch based on the touch parameter TP, the tone can be changed depending on the TP. Specifically, the interpolating processing is performed according to a formula (13). Where, w is a value of one sample of the musical sound data after interpolation, wa is a value of one sample of the musical sound data corresponding to the weakest touch, wb is a value of one sample of the musical sound data corresponding to the strongest touch and a is the interpolation factor of a value from 0 to 1.

w=wb×a+wa(1−a) (13)

Where, a=TP/0x7F

Following the interpolating processing, an envelope (hereinafter referred to ENV) is calculated according to a formula (14) (S404).

ENV=LD×REL (14)

REL is determined as follows.

(a) In the case of F=1,

REL=g

(b) In the case of F=0, KON=0 and PD=0,

REL=REL_old×0.5

(c) In the other cases,

REL=1

Where, REL is an attenuation parameter, REL_old is the REL in a previous sampling period and g is an attenuation variable.

The parameter of g is a time-varying parameter and the value of g is 0.875 in the sampling cycle at the time when F=1 is transferred from the CPU part 230A and 0.750 in a next sampling period, thereafter decreases by 0.125 and keeps 0 after the value of g becomes 0. By doing so, the value of the ENV reaches 0 at eight samples after the F=1 is transferred. The signal processing part 220 holds the REL_old in an internal RAM and updates it to the REL each time the formula (14) is calculated. Therefore, the REL gradually approaches 0 in an exponential manner.

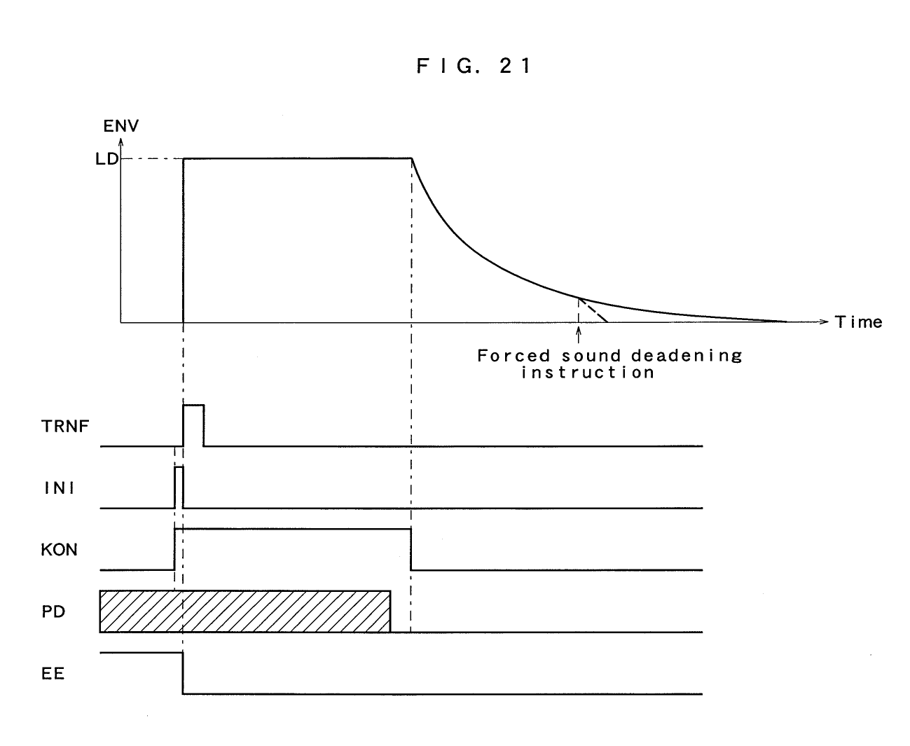

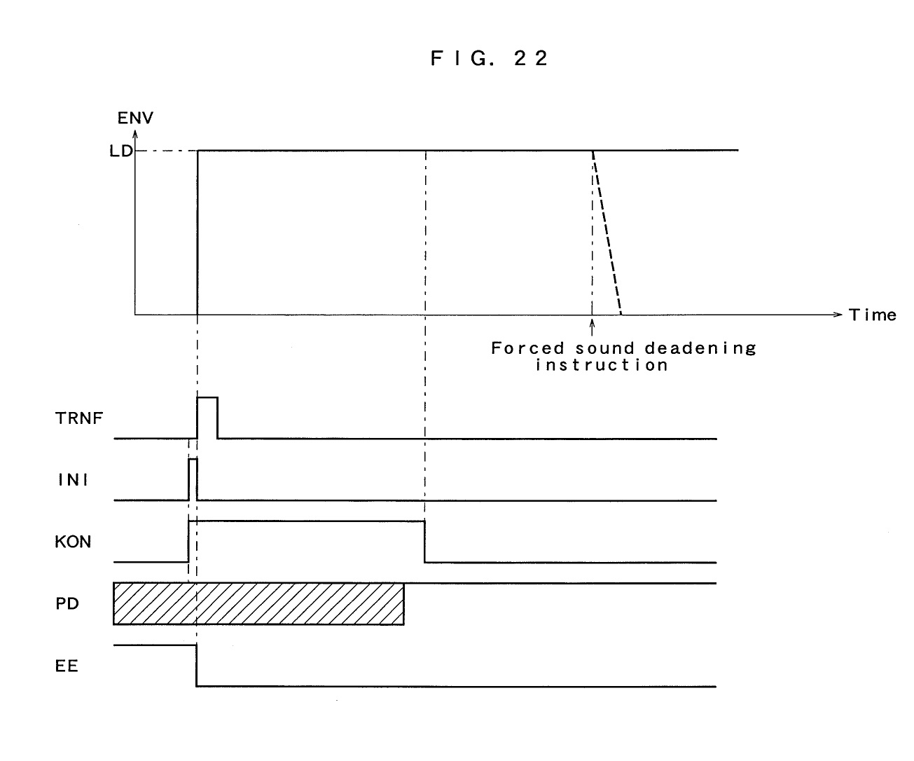

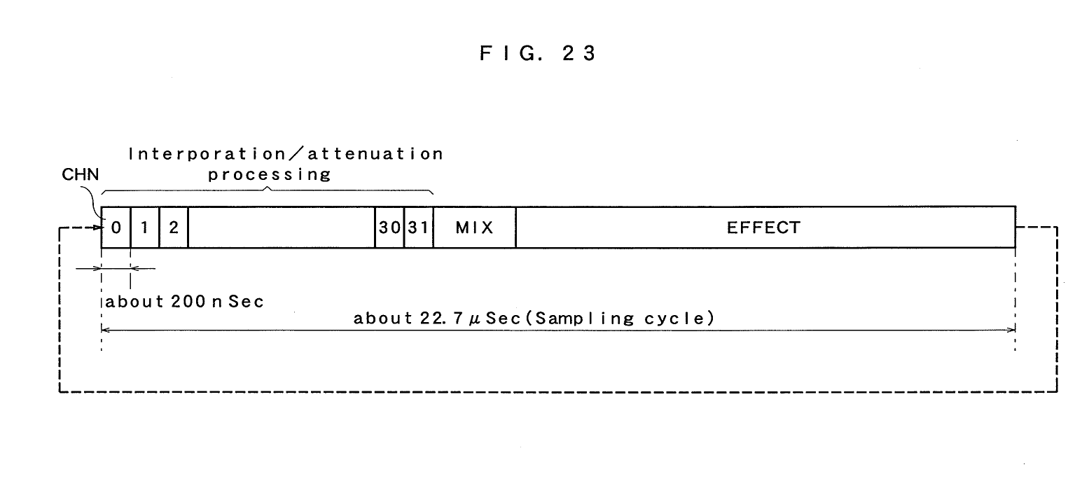

FIGS. 21 and 22 show time variation of the ENV. FIG. 21 shows the case where the value of the PD is 0, that is, the sustain pedal is turned OFF. In this case, the ENV does not change as shown in the above-mentioned case (c) while the value of the KON is 1, and after the value of the KON becomes 0, that is, the key is released, the ENV exponentially attenuates. FIG. 22 shows the case where the value of the PD is 1, that is, the sustain pedal is turned ON. In this case, the state of above-mentioned case (c) continues even when the value of the KON becomes 1 and the value of the ENV at key-touch is maintained. In both cases shown in FIGS. 21 and 22, when a forced sound deadening instruction is made, that is, F becomes 1, as shown in the state of above-mentioned case (a), the REL becomes a time-varying parameter g. Therefore, at the eight sampling cycles shown by a dotted line, the value of the ENV linearly attenuates to 0. One sampling cycle is calculated according to a formula (15).

1/sampling frequency (44.1 kHz)=about 22.7 μseconds (15)

Therefore, the time period of eight sampling cycles is about 182 μseconds.

Following calculation of the ENV, the ENV is compared with a threshold value ENVth (S405). The ENVth is an acoustically inaudible level of value. When the ENV is less than the ENVth at S405, the value of the EE of the corresponding channel in the channel assign table 232 of the CPU part 230A is updated to 1 and the value of the SON of the corresponding channel is updated to 0 (S406). The channel in which the value of the SON is updated to 0 is thereafter managed as the free channel.

Next, digital data W after the envelope processing is found according to a formula (16) (S407).

W=w×ENV (16)

Since the musical sound data is data obtained by digitally recording piano sound per key as described above, even when a level of the ENV does not change with time, a peak value of the W attenuates with time and thus, the musical sound data sounds to be attenuated.

Next, when the value of the WE becomes 1, that is, the musical sound data corresponding to any key-touch reaches the final sample (s1763999 sample) or the value of the EE becomes 1, that is, the ENV reaches the acoustically inaudible level (S408), the signal processing need not be continued. Therefore, since increment of the sector number sn and a toggle operation of the selecting flag D become unnecessary, the procedure jumps to S414. Otherwise, the procedure proceeds to S409 and the sn is incremented. As shown in FIG. 10, the wave end flag WE is a flag recorded in b0 of the musical sound data acquired from the musical sound data buffer 234 and the value of WE only in the s1763999 sample is 1. Until the musical sound data with b0 having a value 0 is read at S403, the value of the WE of a corresponding channel remains to be 1.

When the sector number sn becomes 96 as a result of increment at S410, the procedure proceeds to S411. To read the next musical sound data of one sector, the signal processing part increments the sc of the corresponding channel in the channel assign table 232 and sets the value of the musical sound data read request flag DQ to 1. When the sn is not 96, the procedure proceeds to S412 without performing this processing.

Next, the signal processing part determines whether or not the sn is 127, that is, the musical sound data reaches the final sample in the musical sound data of one sector at S412, and the signal processing part determines that the musical sound data reaches the final sample, the selecting flag D is toggled, that is, the current value is changed to the opposite logic. In this operation, the value of the D of the corresponding channel in the channel assign table 232 is switched, for example, from 0 to 1 and the input of the demultiplexer of the musical sound data buffer 231, for example, 231_0d is switched. Thereby, the read source of the musical sound data is switched from the dual port RAM 231_0a to the dual port RAM 231_0b.

Next, at S414, the signal processing part 220 increments the CHN held therein and when the CHN is not 0, the procedure returns to S401 to proceed to processing of a next channel. However, the CHN is held in a five bit-counter and cyclically updates CH0 to CH31. When the value of the CHN becomes 0 at S415, that is, processing up to CH31 finishes, the procedure shifts to mixing processing (S416).

In the mixing processing, Wn of CH0 to 31 is subjected to mixing processing according to a formula (17).

WX=(W0+W1+ . . . +W31)/32 (17)

Where, Wn (n is an integer 0 to 31 corresponding to the CHN) is W of an arbitrary channel and Wx is a mixing result. Following mixing, effect processing is further performed at S417.

FIG. 23 is a time slot diagram showing signal processing per sampling cycle. In FIG. 23, a left side is the earlier side, and interpolating processing and level control of CH0 to 31 are performed and then, the mixing processing (MIX) of the musical sound of CH0 to 31 and effect processing (EFFECT) such as reverb or chorus is performed. The signal processing part 220 cyclically performs a series of processing every 22.7 μseconds as a sampling cycle.

The above-mentioned signal processing is repeatedly performed every sampling cycle (22.7 μseconds), the processed musical sound data is digital-analog converted by the DA converter of the input and output part 210A every 22.7 μseconds and the result is outputted to the outside through a line out terminal as the desired music sound. The musical sound can be obtained as piano performance sound through an external amplifier and a speaker.

Returning to the description of the main routine by the CPU part 230A in FIG. 13A, processing at S102 and subsequent processing will be described. At S102, the CPU part 230A examines F of all channels in the channel assign table 232. When the channel with the EE having the value 1 exists in the channels with the F having the value 1, the CPU part clears the value of the F of the channel to 0 (S103) and performs the channel assign processing for the channel (S104). As described above, the signal processing part 220 clears the EE at S402.

Next, the CPU part performs the read request of the musical sound data (S105) and sounding control of the signal processing part 220 (S106). S105 and S106 are the same processes as the above-mentioned S130 and 131.

Next, at S107, CPU part searches the channel with the DQ having the value 1, and when such channel exists, issues the read request of the musical sound data of the channel at S108. Search of the channel assign table 232 at S107 and S102 is performed beginning from CH0 in ascending order.

(2) Description of Sounding Delay Time

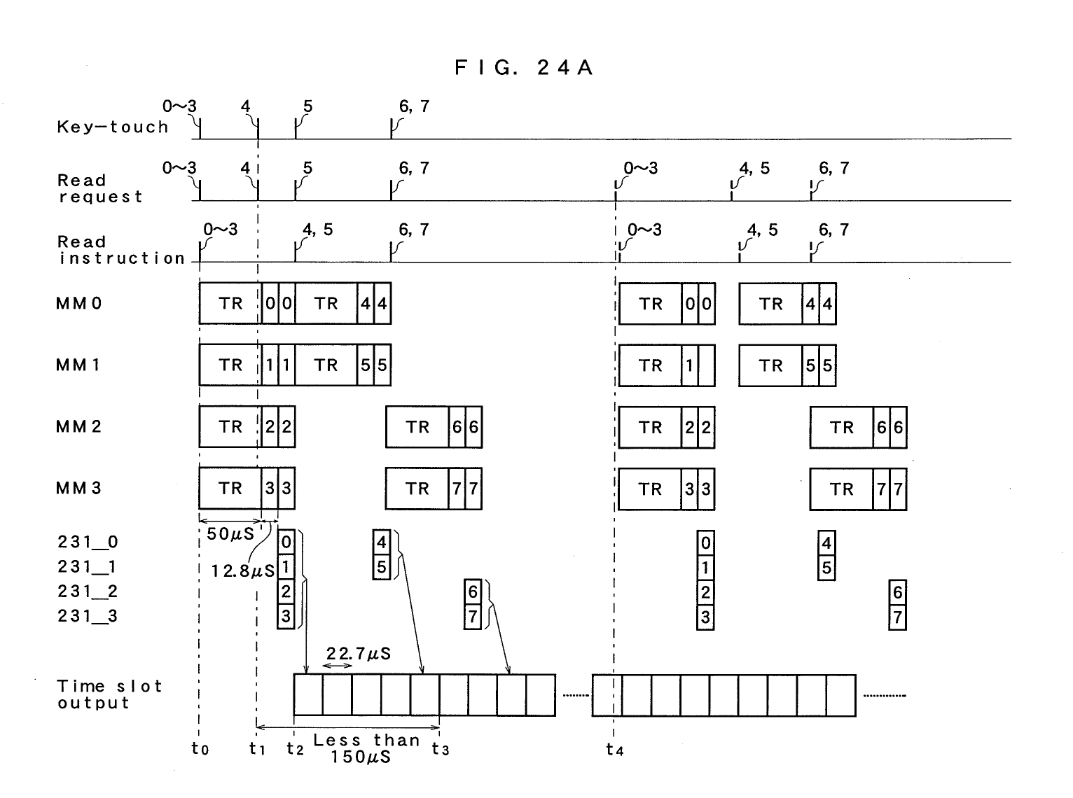

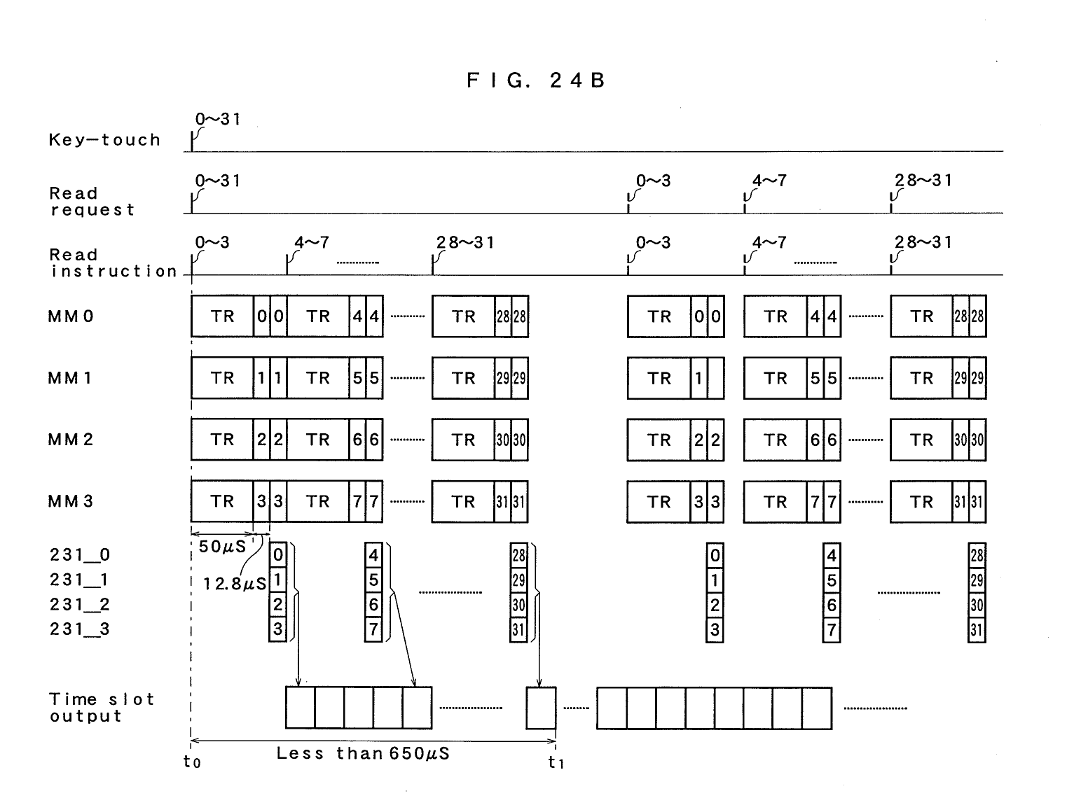

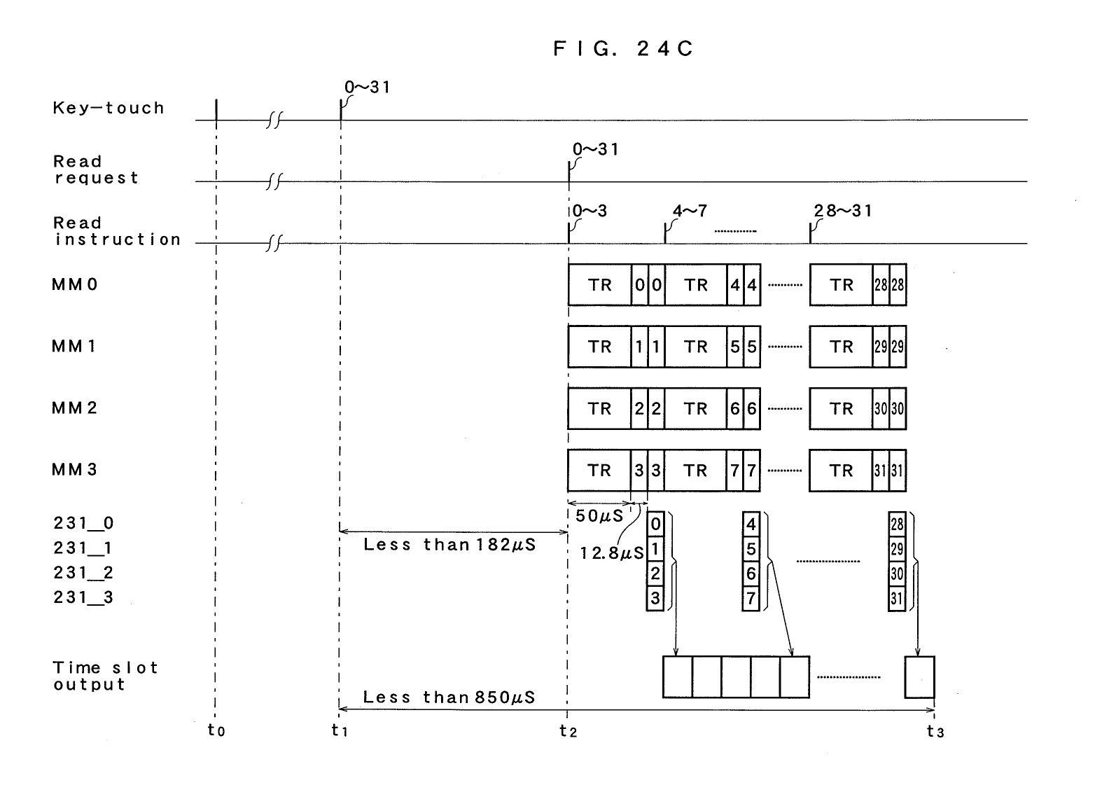

In consideration of the above-mentioned processing, operation performed from key-touch to production of the musical sound and sounding delay time for each key-touch method will be described referring to the time chart shown in FIGS. 24A to 24C and channel assign table 232 shown in FIGS. 6A to 6C.

(2-1) Discrete Key-Touch

FIG. 24A is a time chart for describing a case of discrete key-touch and FIG. 6A shows variation in the parameters in the channel assign table 232 which corresponds to the key-touch. In this case, first, four keys corresponding to the NN of 0x19, 0x1C, 0x1E, 0x20 are simultaneously touched by the master keyboard 300 from a silent state at a time t0 and then, a key with the NN of 0x25, key with the NN of 0x29 and finally, two keys with the NN of 0x2C and 0x2F are touched at tens of μseconds intervals. The key-touches are assigned to CH0 to 7, respectively, by the above-mentioned channel assign processing of the CPU part 230A, and the read requests of CH0 to 7 are outputted to the read instructing part 240 at the timing obtained by adding processing delay of the CPU part 230A to key-touch timing. Further, as described above, the read instructing part 240 transfers the read instructing information to the storage module 100A according to an access status of the group of the nonvolatile storage modules.

During reading of the musical sound data from the nonvolatile memory bank to the memory controller and transfer of data from the memory controller to the access module 200A, the access module 200A cannot transfer the next read instructing information. For this reason, timing at which the read instructing information is transferred to the storage module 100A, which is timing shown in FIG. 24A, the read instruction of CH0 to 7 is transferred from the access module 200A to the storage module 100A. According to the transfer timing, the data in each memory banks 112 to 142 is read from the memory cell array to the I/O register during the read time TR.

After that, the musical sound data is read from the I/O register to the memory controller during the transfer time TT1 and temporarily stored in the musical sound data buffer 231 from the memory controller through the read instructing part 240 during the transfer time TT2.

As described above, the signal processing part 220 performs processing of generating the musical sound by using the musical sound data stored in the musical sound data buffer 231. The signal processing part 220 performs processing of CH0 to 31 every sampling cycle by time-sharing. In other words, the musical sound data of each channel is sequentially used from s0 every 22.7 μseconds.

In CH0 to 3, s0 is used at a first time slot beginning from time t2 in FIG. 24A. Sample s0 in CH4, 5 is started to be used after four time slots from the above-mentioned time slot and then, CH6, 7 are started to be used after three time slots.

In each channel, all musical sound data of 512 Bytes is used to the fullest at a 127th time slot from the time slot using s0. For this reason, as described above, at a time t4 when sn becomes 96, the next musical sound data of 512 Bytes needs to be acquired in advance. The value of the sn is not limited to 96 and may be the other value as long as the musical sound data of 512 Bytes can be acquired before processing next musical sound data of 512 Bytes.

In response to this, at timing shown by a dotted line in FIG. 24A, the read instruction of CH0 to 7 is transferred from the access module 200A to the storage module 100A. The read instruction is transferred basically at intervals of time slot, that is, every 22.7 μseconds.

Next, the sounding delay time will be described. The sounding delay time is time from the key-touch time to generation of the musical sound corresponding to s0. In FIG. 24A, the maximum sounding delay time of CH4 is a time from t1 to t3 and the sounding delay time is equal to or smaller than 150 μseconds. Since this is sufficiently smaller than 1 msecond as an acceptable scope of the sounding delay time, in the case shown in FIG. 24A, the musical sound generating system in the present embodiment can be used as the musical sound generating system such as an electronic musical instrument.

(2-2) Intensive Key-Touch

Next, a case where sound is produced at a time by using all of 32 channels will be described. FIG. 24B is a time chart showing operation in the case where 32 keys are simultaneously touched at the time t0 by the master keyboard 300 and FIG. 6B shows variation in the parameters in the channel assign table 232, which correspond to the key-touches. Such key-touch method is not performed in normal musical performance so frequently.

In such case, for example, as shown in FIG. 6B, 32 keys corresponding to the NN of 0x28 to 0x47 are simultaneously touched NN. The key-touches are assigned to CH0 to 31 by the above-mentioned channel assign processing of the CPU part 230A, the read request of CH0 to 31 is outputted to the read instructing part 240 at timing obtained by adding processing delay of the CPU part 230A to the key-touch timing and the read instructing information corresponding to the read request is transferred from the access module 200A to the storage module 100A. Thereafter, as shown in FIG. 24B, the musical sound data is transferred to the musical sound data buffer 231 to generate the musical sound.

In this case, the sounding delay time becomes the longest in CH28 to 31 and the sounding delay time is the time from t0 to t1, that is, equal to or smaller than 650 μseconds in FIG. 24B. Since this is sufficiently smaller than 1 msecond as the acceptable scope of the sounding delay time, also in the case shown in FIG. 24B, the musical sound generating system in the present embodiment can be used as the musical sound generating system such as the electronic musical instrument.

(2-3) Intensive Key-Touch after Rapid Sound Deadening

Finally, the case where sound in produced by using all of the 32 channels after the rapid sound deadening will be described referring to FIGS. 24C and 6C. In this case, for example, in a state of the key-touch shown in (2-2), that is, in a state where 32 keys corresponding to the NN of 0x28 to 0x47 being touched at the time t0 as shown in 6C, when 32 keys corresponding to the NN of 0x48 to 0x67 are newly touched at the time t1, sound of channels exceeding the maximum number of sounding channels (32 channels) is produced.

In controlling such sounding of the channels exceeding the maximum number of sounding channels (32 channels), the sound of 32 channels is rapidly deadened in advance and the value of the EE of the 32 channels is set to 1. After the sound is deadened to the acoustically inaudible level, new key touches need to be assigned to the 32 channels. In this case, the sounding delay time becomes the longest.

Such rapid sound deadening is performed for 182 μseconds corresponding to eight sampling cycles immediately after the key-touch at the time t1 in FIG. 24c. In FIG. 6C, since all of the channels become the channels for new key-touches in the state where the already touched keys are sounded without being released, the values of both the KON and SON start from 1. Then, according to the rapid sound deadening processing by the signal processing part 220, the value of the EE becomes 1 and the value of the SON becomes 0. As a result, according to the channel assign processing by the CPU part 230A, the read instructing information of CH0 to 31 is transferred to the storage module 100A. The time chart after the processing is the same as the time chart shown in FIG. 24B.

In this case, the sounding delay time becomes the longest in CH28 to 31 and the sounding delay time is the time from t1 to t3, that is, equal to or smaller than 850 μseconds in FIG. 24C. Since this is sufficiently smaller than 1 msecond as the acceptable scope of the sounding delay time, the musical sound generating system in the present embodiment can be used as the musical sound generating system such as the electronic musical instrument.

As described above, in the musical sound generating system in the first embodiment, the musical sound data is multiplexed by recording the musical sound data in each of the nonvolatile memory banks 112 to 142, and the data reading part 120 reads the musical sound data in parallel from the plurality of nonvolatile memory banks according to the read instruction from the access module 200A. For this reason, in a system in which it cannot be predicted which pitch of musical sound data is required to be read, such as the musical sound generating system, a plurality of pieces of data can be read from the plurality of nonvolatile storage modules in parallel. Therefore, the sounding delay time can be made smaller than 1 msecond as its acceptable scope. In other words, even when the prevailing mass flash memory is used as the memory for musical sound data, an inexpensive and compact musical sound signal generating device can be realized.

### Second Embodiment

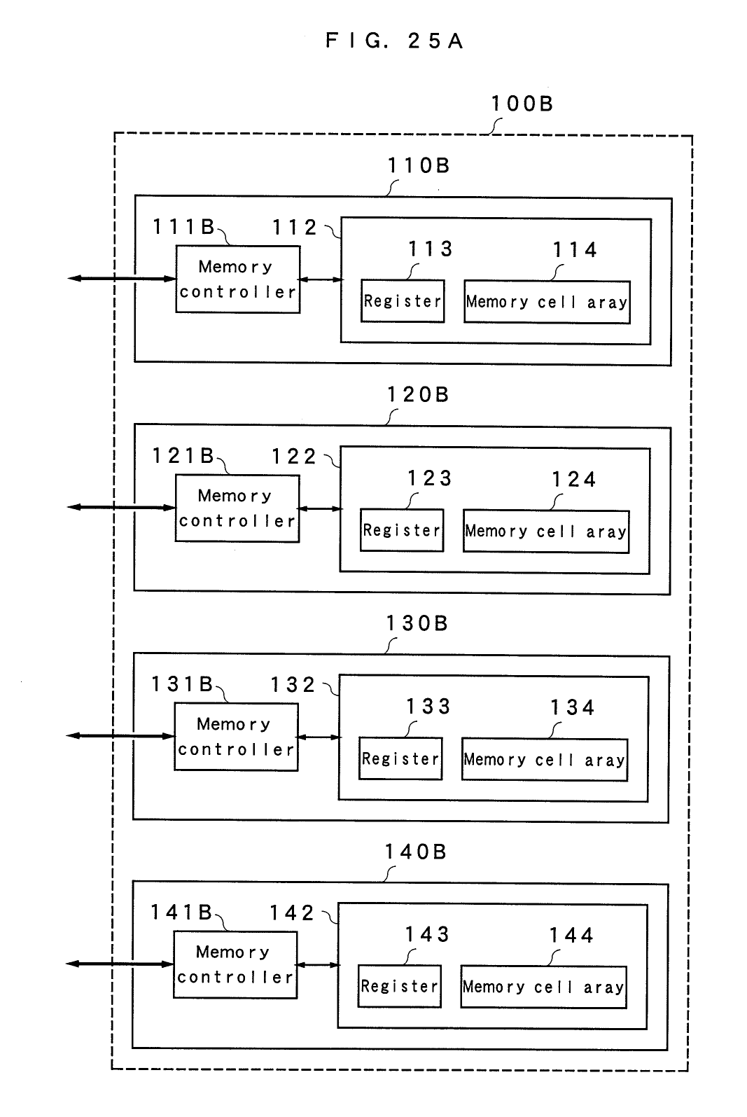

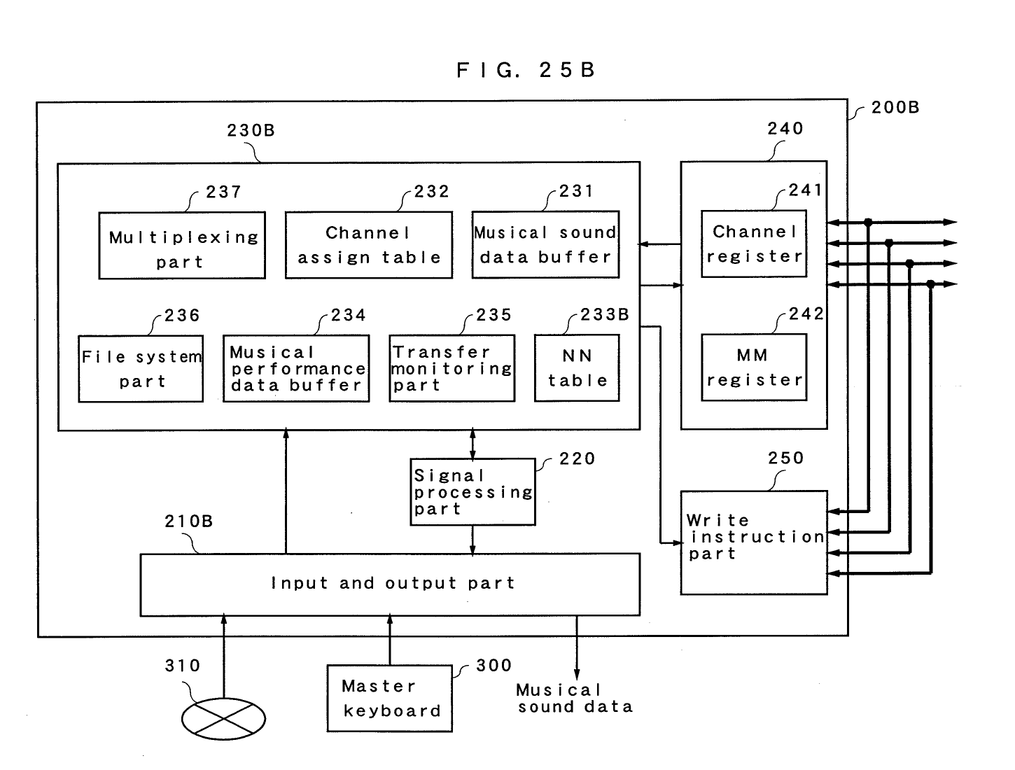

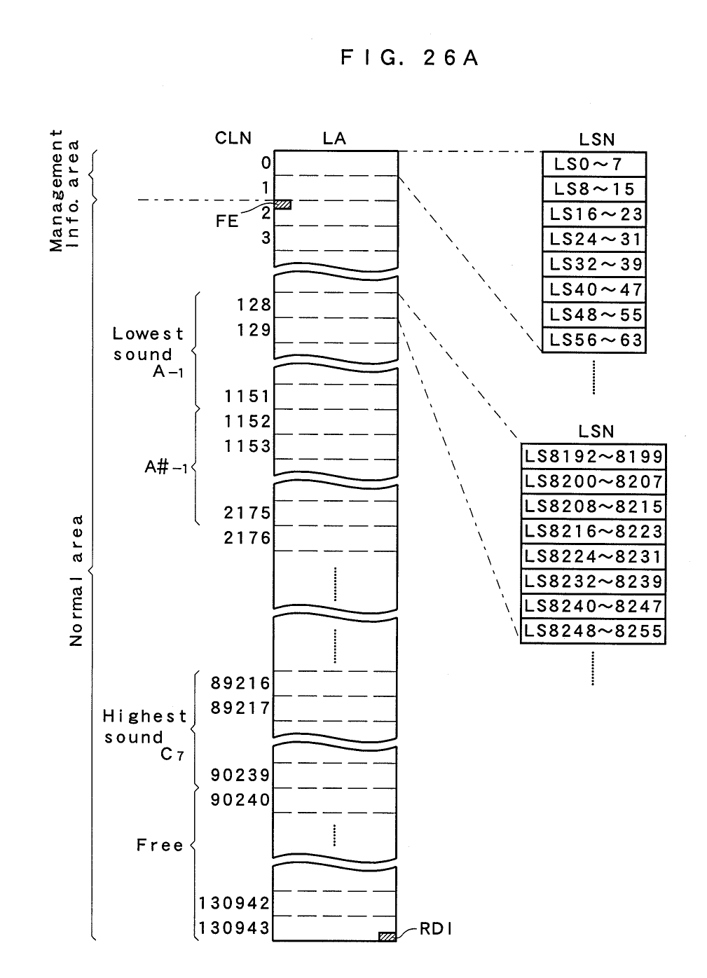

FIG. 25A and FIG. 25B are block diagrams of a musical sound generating system according to a second embodiment of the present invention. The musical sound generating system in the present embodiment includes a storage module 100B and an access module 200B. The storage module has four nonvolatile storage modules 110B, 120B, 130B, 140B and the nonvolatile storage module 110B includes a memory controller 111B and nonvolatile memory bank 112. The other nonvolatile storage modules have a similar configuration. The access module 200B includes an input and output part 210B, a signal processing part 220, a CPU part 230B, a read instructing part 240 and a write instructing part 250. A basic configuration of this musical sound generating system is the same as that of the musical sound generating system in the first embodiment and differences are following (a) to (c).

(a) The CPU part 230B includes an NN table 233B, a file system part 236 and a multiplexing part 237. The other blocks are the same as those in the first embodiment. The CPU part 230B writes musical sound data downloaded from the Internet 310 to the storage module 100B through the write instructing part 250 and manages the musical sound data as a file.

(b) The memory controllers 111B, 121B, 131B, 141B each has a logical-physical converting function.

(c) The Internet 310 is connected to the input and output part 210B so that necessary data can be downloaded according to the user's instruction.

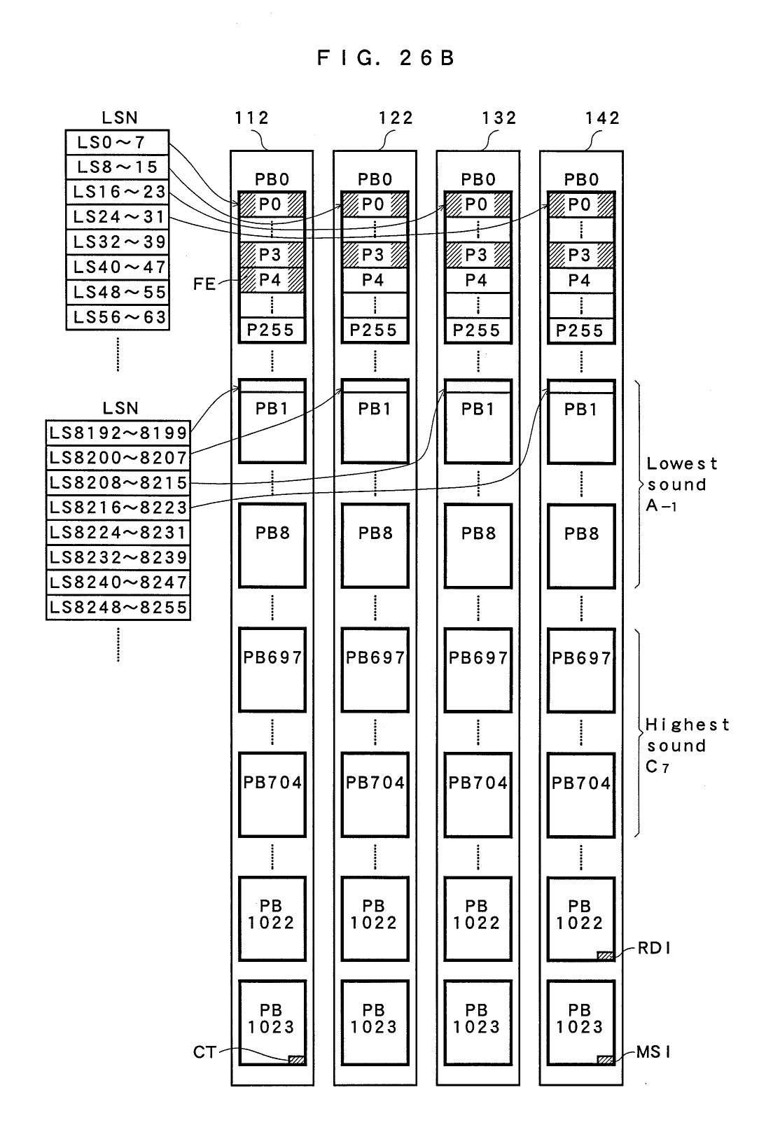

FIG. 26A is an explanatory diagram showing relationship among a logical address space, cluster number CLN and logical sector number LSN, and FIG. 26B is an explanatory diagram of a physical address space showing relationship between the logical sector number LSN and a structure of the memory cell array 114 to 144 in the nonvolatile memory bank 112 to 142. Here, the logical address space consists of CL0 to CL130943. One cluster has a capacity of 32 kBytes. On the other hand, the nonvolatile memory banks 112 to 142 have physical blocks PB0 to PB1023, respectively. Each physical block is formed of 256 pages (P0 to P255). Here, the musical sound data is held in PB1 to PB704 of each of the nonvolatile memory banks 112 to 142. Here, the logical address space corresponds to PB0 to PB1022. In other words, PB1023 is an area which cannot be read/written by logical addressing (hereinafter referred to as a system area). This prevents the user from wrongly erasing data and the manufacturer can write data to the area by direct physical addressing.

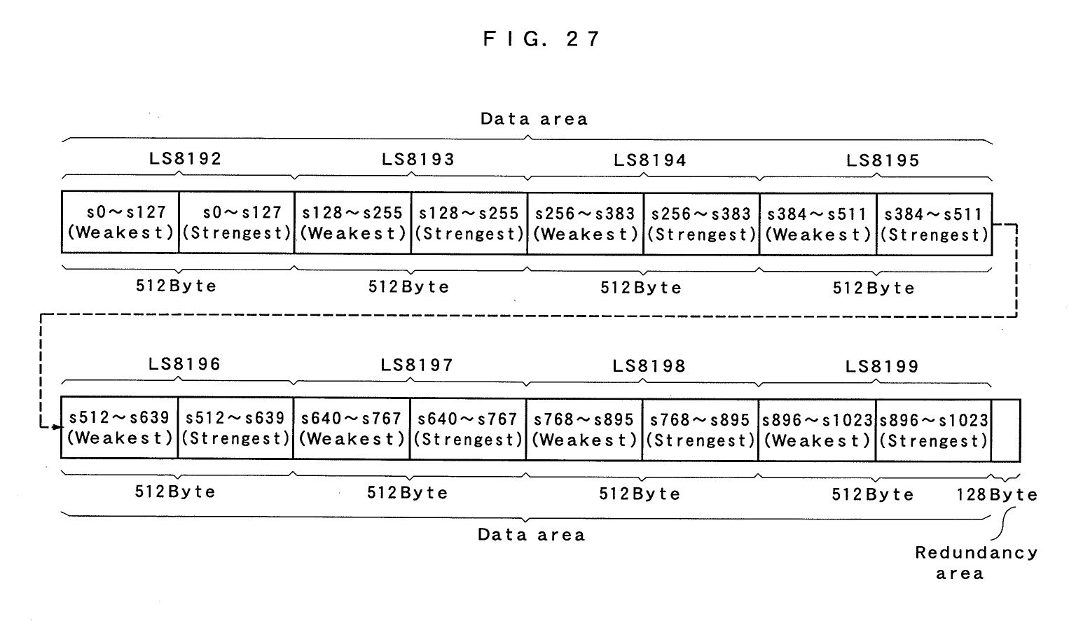

FIG. 27 is a diagram showing a record format of each page which records the musical sound data therein using the page p0 of a physical block PB1 as an example. Each page of the physical block includes a data area of 4096 Bytes and a redundant area of 128 Bytes. In the present embodiment, the data area is divided into eight sectors. Each sector has a capacity of 512 Bytes. The redundant area is not used.

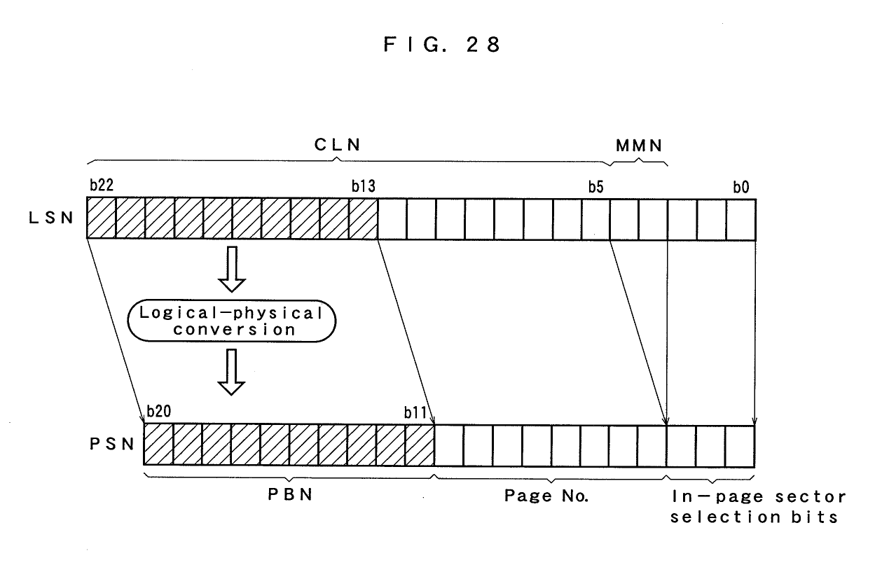

FIG. 28 is a bit format correspondence between the logical sector number LSN and the physical sector number PSN. In FIG. 28, bits b0 to b2 of the LSN are in-page sector selection bits, b3 and b4 represent the MMN, b5 to b12 represent the page number and b13 to b22 represents a logical block number LBN. The cluster number CLN corresponds to b22 to b5. The MMN corresponds to bits for selecting the nonvolatile storage modules 110B to 140B, and selects the nonvolatile storage module 110 when the value of the MMM is 0, selects the nonvolatile storage module 120 when the value of the MMM is 1, selects the nonvolatile storage module 130 when the value of the MMM is 2 and selects the nonvolatile storage module 140 when the value of the MMM is 3. The PBN is determined by logical-physical conversion of b22 to b13 of the LSN by the memory controllers 111B to 141B. Bits of b12 to b5 and b2 to b0 of the LSN correspond to bits of b10 to b3, b2 to b0 of the PSN, respectively.

However, the bit format of the LSN in FIG. 28 is an example in the case where the parallel number of the storage module 100B is four and the numbers of bits assigned to the MMN may be changed depending on the parallel number. For example, when the parallel number is two, the number of bits assigned to bank select is 1 (b3) and accordingly, the page number is assigned to b11 to b4 and the LBN is assigned to b21 to b12. In-page sector selection bits are bits corresponding to the quotient obtained by dividing the page by the sector size. In the present embodiment, given that a page size is 4096+128 Bytes and a sector size is 512 Bytes, that is, as shown in FIG. 3, one page is divided into eight sectors, the in-page sector selection bits are selected by lower three bits of the above-mentioned physical address. The page size and sector size are not limited to the above-mentioned values and the in-page sector selection bits may be varied according to the values of the page size and sector size.

Each of the memory controllers 111B to 141B has an interface circuit and buffer for converting the read instructing information supplied from the access module 200B into read commands to the nonvolatile memory banks 112 to 142. The memory controllers 1118 to 141B, as shown in FIG. 28, have a logical-physical converting function of converting the upper 10 bits of the LSN to the PBN. The interface circuit and logical-physical converting function are installed in a commercially available memory card (for example, SD card) and description thereof is omitted.

Next, differences between blocks of the access module 2008 and those in the first embodiment will be described referring to FIG. 25B.

The file system part 236 of the CPU part 230B serves to manage the musical sound data as a file. The multiplexing part 237 multiplexes the musical sound data in writing the musical sound data as a file. Details of the file system part 236 and multiplexing part 237 will be described later.

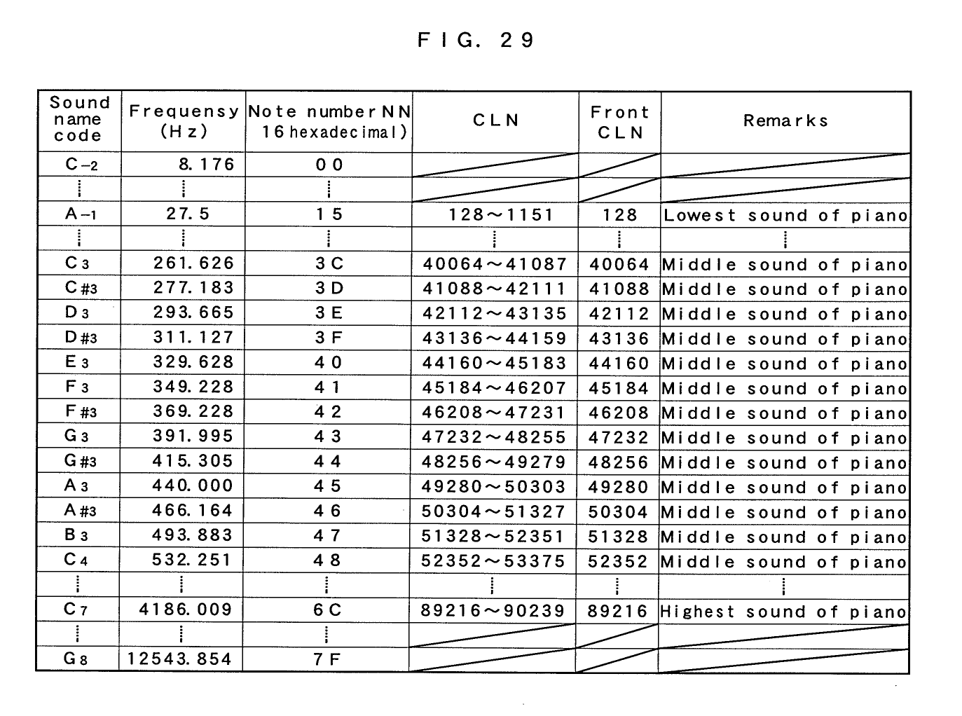

FIG. 29 is an explanatory diagram showing the NN table 233B held in the CPU part 230B. The NN table 233B in the present embodiment is a table showing relationship between the note number NN and the cluster number CLN which stores the musical sound data corresponding to the NN.

The read instruction part 240 is the same as the read instructing part 240 in the first embodiment.

The write instructing part 250 transfers a write instruction of the musical sound data by the CPU part 230B to the storage module 100B.

### [Initial State]

First, initialization performed by the manufacturer prior to shipment of the storage module 100B or musical sound generating system shown in FIGS. 25A and 25B will be described.

A writing device such as a personal computer conforming to the FAT file system on the manufacturer physically formats the nonvolatile storage modules 100B to 140B. After that, as shown in FIG. 26A, the writing device allocates management information such as the FAT table and route directory entry to a management information area (CL0, CL1) in the logical address space and allocates the musical sound data to a normal area after the cluster CL2.

Here, as shown in FIGS. 26A and 26B, P0 of PB0 of the nonvolatile memory bank 112 corresponds to LS0 to 7 and P0 of PB0 of the nonvolatile memory bank 122 corresponds to LS8 to 15. Similarly, P0 of PB0 of the nonvolatile memory bank 132 corresponds to LS16 to 23 and P0 of PB0 of the nonvolatile memory bank 142 corresponds to LS20 to 31. The relationship follows the bit format of the LSN and PSN in FIG. 28.

Next, the musical sound data is serially allocated from a cluster (CL128) obtained by offsetting from a leading logical address by 4 MBytes and a lowest sound name

According to this allocation, the management information is written to P0 to P3 of PB0 of the nonvolatile memory banks 112 to 142 and the musical sound data is written to PB1 and a subsequent area. CL128 as a leading address of the musical sound data, a file name or information on time when the musical sound data is stored are held in a file entry (FE). The file entry (FE) is allocated to the leading 512 Bytes of CL2 as shown in FIG. 26A and written to P4 of PB0 of the nonvolatile memory bank 112 in terms of the physical space as shown in FIG. 26B.

The logical address of the file entry can be traced from the route directory entry in the management information. The FAT file system is a common technique and thus detailed description thereof is omitted.

Also in the second embodiment, with respect to two kinds of data of the strongest touch and weakest touch, the piano musical sound data is digitally recorded at the sampling frequency of 44.1 kHz. As represented by the formula (4), for 1764000 samples, as shown in FIG. 26B, the musical sound data of 88 keys extending from the lowest piano sound to highest sound is written to the physical blocks PB1 to PB704 of the nonvolatile memory bank 112 in ascending order. The same data is written to each of the nonvolatile memory banks 122 to 142. Thereby, the same data is multiplexed and recorded in the four parallel nonvolatile memory banks. For example, in FIG. 26B, data in LS8192 to LS8199, LS8200 to LS8207, LS8208 to LS8215, LS8216 to LS8223, which are written to P0 of PB1 of each nonvolatile memory bank, are identical to one another.

Data of the lowest piano sound is written to PB1 to PB8 of each memory bank and the musical sound data of 1764000 samples from the forefront sample (s0) to the rearmost sample (s1763999) immediately after key-touch is written to the memory banks from P0 of PB1 in ascending order. As shown in FIG. 27, the two kinds of musical sound data of the weakest touch and strongest touch forming a pair is written in units of 512 Bytes. The bit format showing one sample of the musical sound data is the same as that in the first embodiment in FIG. 10.

As shown in FIG. 28, the logical address is logical/physical converted into the physical address by each of the memory controller 111B to 141B. For simplification, it is assumed that all physical blocks are normal blocks. However, when an initial failure block exists, use of the initial failure block may be prevented according to a logical-physical converting method. A logical-physical converting table (CT in FIG. 26B) for logical-physical conversion is held in PB1023 of the nonvolatile memory bank 112. The logical-physical conversion is a common technique and thus detailed description thereof is omitted.

Furthermore, in initialization, as shown in FIG. 26B, characteristic information (hereinafter referred to as recorded data characteristic information, RDI in the figure) of the piano musical sound data recorded in the storage module 100B is written to a final page of the physical block PB1022 of the nonvolatile memory bank 142, and information on a memory structure of the storage module 100B (hereinafter referred to as memory structure information, MSI in the figure) is written to a final page of the physical block PB1023. The recorded data characteristic information and memory structure information are the same as those in the first embodiment and are shown in FIGS. 11 and 12, respectively.

Operation of the musical sound generating system thus configured according to the second embodiment of the present invention will be described.

### [Initializing Processing at Power-on]

After power-on of the access module 200B and storage module 100B, the modules each starts initializing processing. The initializing processing of the storage module 100B is performed by the respective memory controllers and when the initialization is completed, an access to the access module 200B is permitted. The initializing processing of the memory controller is commonly known and thus description thereof is omitted.

The access module 200B performs its initializing processing separately in the read instructing part 240 and CPU part 230B.

As in the first embodiment, the read instructing part 240 performs initializing processing at S200 of the flow chart of FIG. 14A. In the initializing processing, when receiving access permission from all nonvolatile storage modules of the storage module 100B, the read instructing part 240 notifies accessibility to the CPU part 230B.

Meanwhile, the CPU part 230B of the access module 200B performs initializing processing at S100 same as that in the first embodiment (FIG. 13A). In the initializing processing, the CPU part 230B reads the FAT table and file entry which are stored in PB0 of the nonvolatile memory banks 112 to 142 to the file system part 236, and the file system part 236 recognizes a start cluster number (CL128) of the musical sound data stored previously in the storage module 100B.

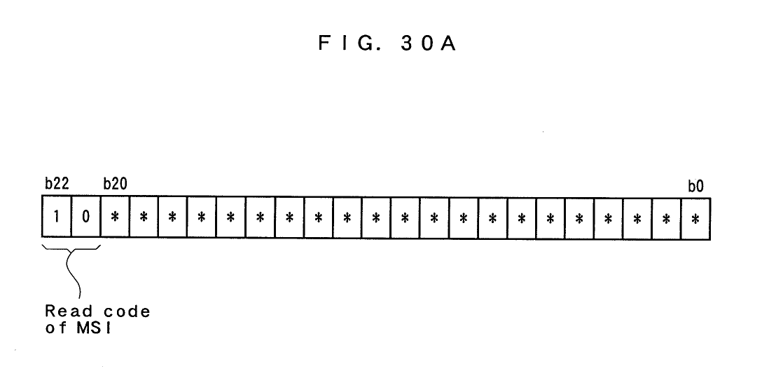

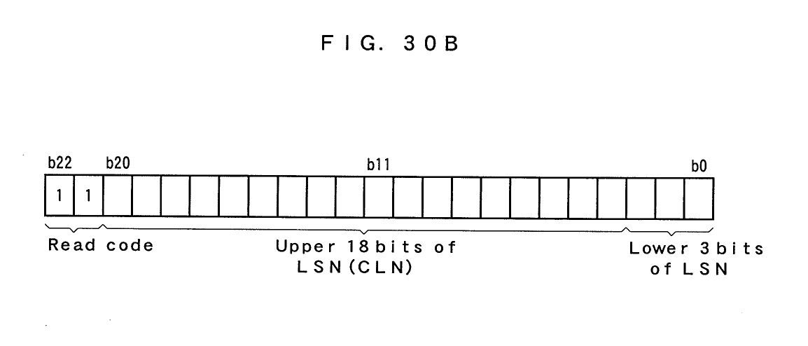

After that, the access module 200B also transfers the read instructing information of the recorded data characteristic information and memory structure information to the storage module 100B through the read instructing part 240. Thereby, the CPU part 230B reads the recorded data characteristic information stored in the PB1022 of the nonvolatile memory bank 142 and memory structure information stored in PB1023. FIG. 30A shows the read instructing information for reading the memory structure information. In FIG. 30A, b22 to b21 are read codes of the memory structure information. “*” is a symbol representing any value. The other initializing processing is the same as that in the first embodiment.

When acquiring the memory structure information shown in FIG. 12, the CPU part 230B finds the parallel number according to the formula (5) based on the number of nonvolatile storage modules. In the present embodiment, the number of nonvolatile storage modules is four. The bit format of the LSN is determined depending on the parallel number thus found. In the present embodiment, since the parallel number is four, the number of bits assigned to the MMN is two and the bit format of the LSN has 23 bits as shown in FIG. 28. When the number of nonvolatile storage modules is, for example, two, the parallel number is two, the number of bits assigned to MMN is 1 (b3) and accordingly, the page number is assigned to b11 to b4 and the PBN is assigned to b21 to b12.

As in the first embodiment, the CPU part 230B finds the maximum number of channels per module, the number of total samples per sector usn and the number of necessary physical blocks per note according to formula (6) to formula (8). Then, the file system part 236 determines the PBN corresponding to each note of the lowest sound A₋₁ to highest sound C₇ based on the start cluster (CL128) of the musical sound data extracted from the file entry and generates the NN table 233B shown in FIG. 29.

In the above-mentioned main routine, the CPU part 230B read the recorded data characteristic information and memory structure information and finishes the initializing processing (S100) after the setting processing of various parameters. When receiving notification of accessibility from the read instructing part 240, the CPU part 230B shifts the procedure from S110 to the normal operation processing S101, enables interrupt and accepts the musical performance data from the external master keyboard 300.

### [Processing During Normal Operation]

Since a basic operation in the present embodiment is the same as that in the first embodiment, only two differences, that is, (1) generation of the read instructing information and (2) writing processing of the musical sound data will be described.

(1) Generation of Read Instructing Information

The CPU part 230B performs channel assign processing according to the key-touch operation of the master keyboard 300 and then, sends the read instructing information of the musical sound data along with the read request to the read instructing part 240. The read instructing information is found according to following procedures.

(a) The leading CLN is found by referring the NN table 233B based on the NN of the key-touch data.

(b) The LSN is found according to the leading CLN, SC and formula (18).

LSN=(leading CLN<<6)+[{(SC&0xFFF8)<<2}|(SC&0x0007)] (18)

Where, the LSN found according to the formula (18) is the LSN in the case where the value of (b4, b3) is 0 and the value of the MMN is 0. & is an operator for obtaining a logical AND, | is an operator for obtaining a logical OR and << is an operator for bit shift to the left. Where, “0x” is a sign representing the hexadecimal number. The logical sector number LSN of b5 to 22 shown in FIG. 28 can be obtained by shifting the leading CLN in the NN table by six bits in the formula (18). The page number can be obtained by masking b0 to b2 of the sector counter SC and shifting by two bits. Furthermore, by adding the lower three bits of the sector counter, the LSN can be obtained.

(c) As shown in FIG. 30B, the read instructing information is found according to a formula (19) based on the LSN found by the formula (18). The upper 18 bits of the LSN correspond to the CLN.

Read instructing information=0x6000000|upper 18 bits of LSN|lower three bits of LSN (19)

In this manner, the CPU part 230B determines the read instructing information and sends it to the read instructing part 240. As described above, the read instructing part 240 selects the nonvolatile storage module used by the MM register 242. The read instructing part 240 transfers the read instructing information thus obtained to one of the selected nonvolatile storage modules 100B to 140B. Operation of reading the musical sound data is the same as that in the first embodiment. However, as described above, in the present the first embodiment 0 bits of b20 to b11 of the read instructing information in FIG. 30B are converted into the PBN as shown in FIG. 28 by the logical-physical converting processing of the memory controllers 111B to 141B and the obtained PSN is given to the nonvolatile memory banks 112 to 142.

A series of subsequent processing before outputting of the musical sound is the same as that in the first embodiment and the sounding delay time can be made 1 msecond or less in the same manner.

(2) Writing Processing of Musical Sound Data

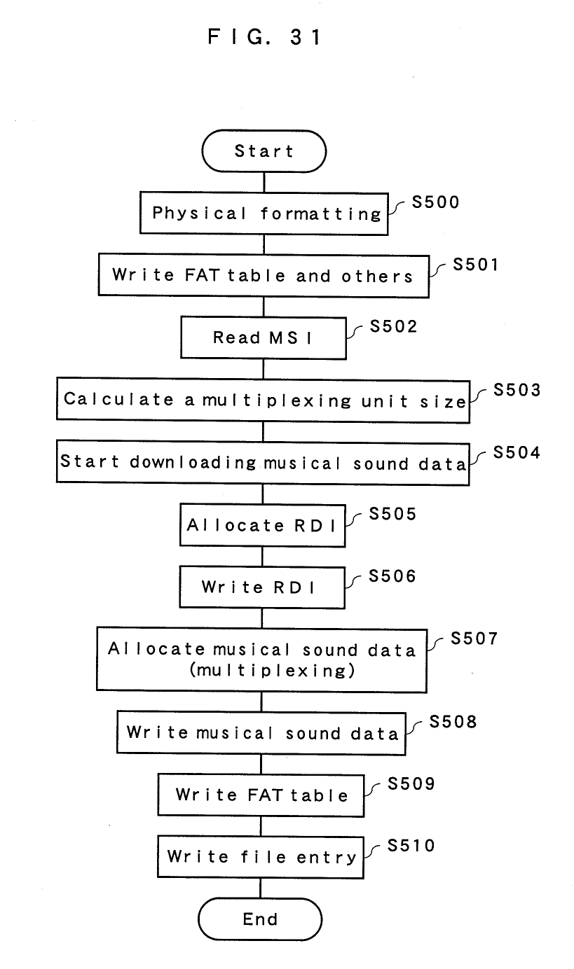

Next, writing processing of the musical sound data by the access module 200B will be described referring to mainly FIG. 31. FIG. 31 is a flow chart showing the musical sound data writing processing by the access module 200B. Writing of the musical sound data starts with the user's write instruction through the input and output part 210B.

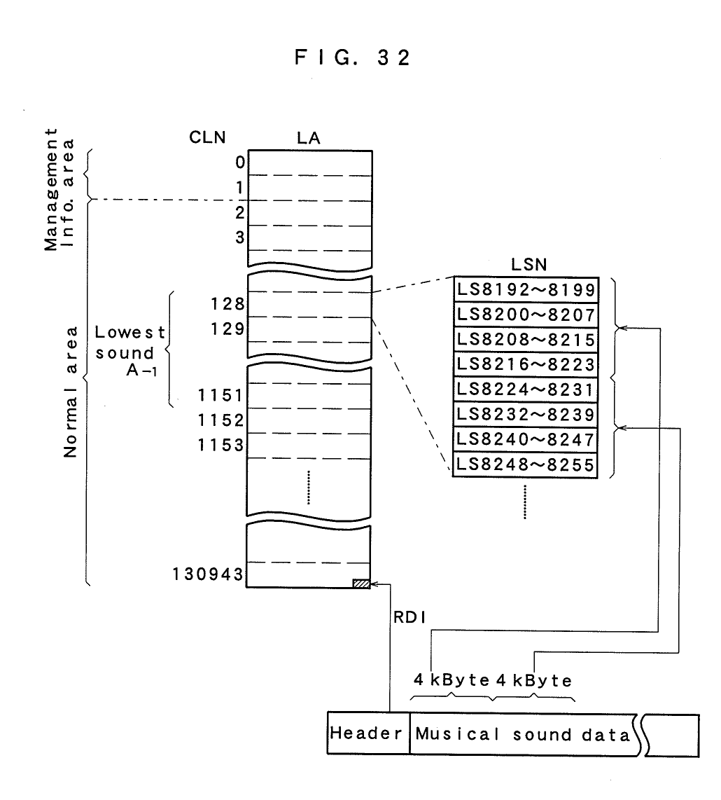

First, prior to writing of the musical sound data, the access module 200B performs physical formatting so as to erase data stored in the nonvolatile storage modules 110B to 140B (S500). FIG. 32 is an explanatory diagram showing file allocation of the musical sound data obtained through the Internet 310. Once the logical address space is logically erased by physical formatting, the file system part 236 transfers an erasure instruction to the nonvolatile storage modules 110B to 140B through the write instructing part 250. Detailed description of specification of the erasure instruction is omitted.

Here, for simplification, in FIG. 28, it is assumed that the b22 to b13 of the LSN correspond to b20 to bll of the PSN in a one-to-one relationship. In this case, PB0 to PB1022 of the nonvolatile memory banks 112 to 142 are physically erased according to the above-mentioned erasure instruction. As described above, PB1023 is outside of the scope of the logical address and thus, is not physically erased. Furthermore, the FAT table and others showing erasure of the physical blocks PB0 to 1022 are recorded in PB0 (S501).

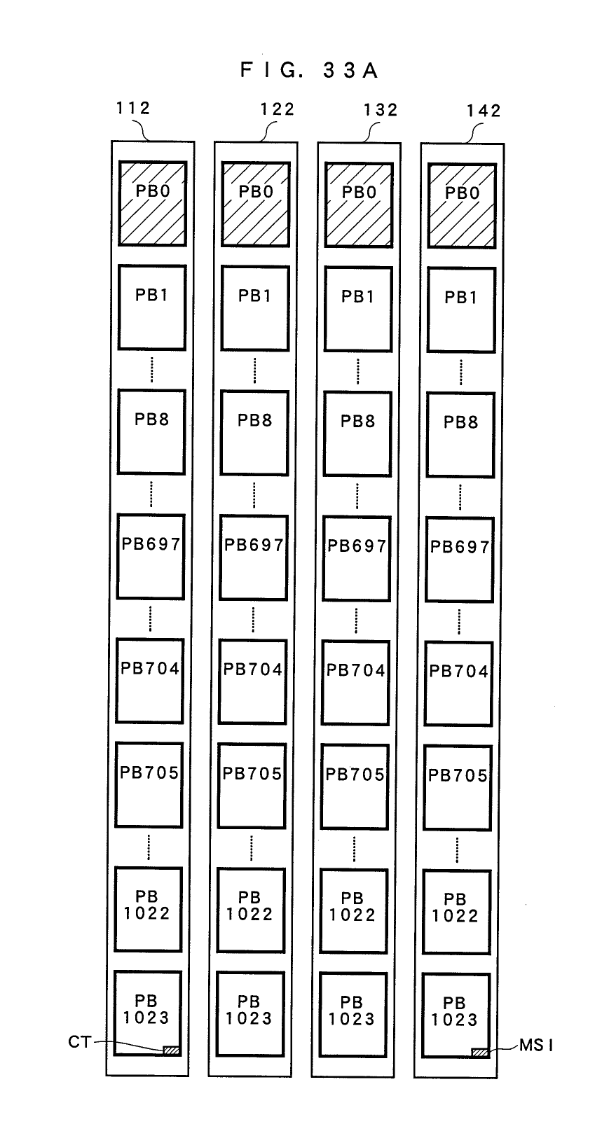

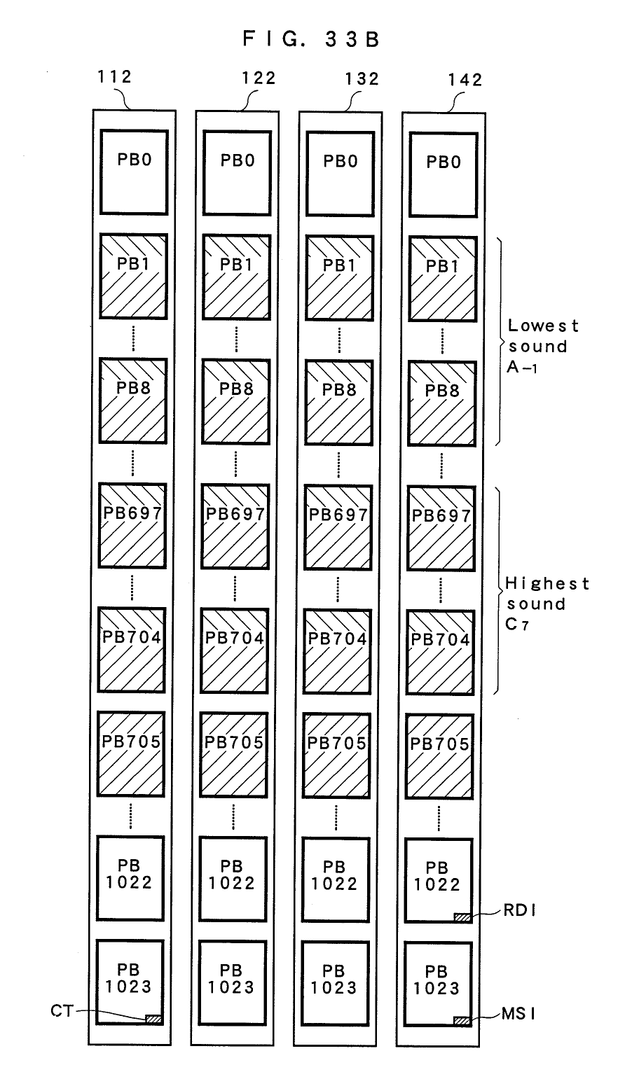

FIG. 33A is an explanatory diagram showing a storage state of the nonvolatile memory banks 112 to 142 before writing of the musical sound data. In FIG. 33A, PB0 of the nonvolatile memory banks 112 to 142 stores the data such as FAT table for managing the fact that all normal area is physically erased by writing after the above-mentioned physical formatting (S500). Accordingly, all of PB1 to PB1022 of the nonvolatile memory bank 112 to 142 are erased state.

Next, the access module reads the memory structure information (MSI) stored in PB1023 of the nonvolatile memory bank 142 (S502). The multiplexing part 237 defines a page size in the memory structure information (4 kBytes) as a multiplexing unit size (S503).

Next, the CPU part 230B starts downloading of the musical sound data from the Internet 310 according to a user's download instruction inputted through the input and output part 210B (S504).

As shown in FIG. 32, information downloaded from the Internet has a format including a header and musical sound data. The header contains musical sound data length and recorded data characteristic information RDI. The CPU part 230B allocates the recorded data characteristic information to the rearmost LSN of CL130943 (S505) and the write instructing part 250 writes the recorded data characteristic information according to the write instruction information (S506). At this time, the write instruction information is transferred to the nonvolatile storage module 140B and the memory controller 141B writes the recorded data characteristic information to the rearmost PSN of P255 of PB1022 of the nonvolatile memory bank 113.

In the above-mentioned writing, when the physical block as a writing destination is a bad block, the memory controller 141B searches another free physical block and rewrites the data to the free block and registers the free block in the logical-physical converting table. The same applies to the other memory controllers 111B to 131B.

Next, as shown in FIG. 32, the multiplexing part 237 of the CPU part 230B multiplexes the musical sound data of parallel number (4 parallel) in the logical address space every multiplexing unit size (4 kBytes) and sends the multiplexed musical sound data to the file system part 236. The file system part 236 allocates the multiplexed musical sound data to the logical address space (S507). In FIG. 32, for simplification, although CL128 is used as the leading cluster to which the musical sound data is allocated, any free cluster may be used as the leading cluster.

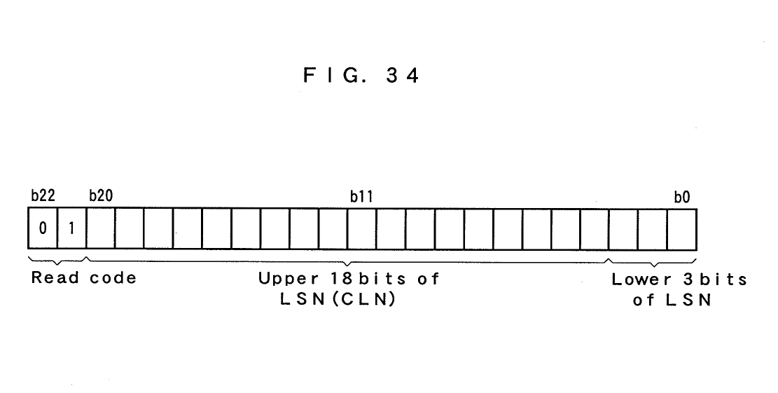

With the above-mentioned allocation, the CPU part 230B sends the LSN shown in FIG. 28 to the write instructing part 250 and the write instructing part 250 removes bits b3 and b4 from the LSN and generates write instruction information shown in FIG. 34. Then, the write instructing part 250 writes the musical sound data by transferring the write instruction information to the storage module 100B (S508). At this time, the nonvolatile storage module as the transfer destination is determined depending on the MMN of the LSN shown in FIG. 28. For example, since the value of the MMN of LS8192 to 8199 in FIG. 32 is 0, the musical sound data corresponding to LS8192 to 8199 is written to the nonvolatile storage module 110B.

After that, writing of the FAT table (S509) and writing of the file entry (S510) are performed so as to register the musical sound data and recorded data characteristic information corresponding to the musical sound data as a set of one musical sound data file.

By multiplexing and writing the musical sound data from the lowest sound to the highest sound to the nonvolatile memory banks 112 to 142, the storage state changes from the state shown in FIG. 33A to a state shown in FIG. 33B. FIG. 33B is an explanatory diagram showing the storage state of the nonvolatile memory banks 112 to 142 after writing of the musical sound data. In FIG. 33B, the musical sound data is stored in PB1 to PB704 of the nonvolatile memory banks 112 to 142 and the recorded data characteristic information is stored in PB1022 of the nonvolatile memory bank 142. Since the management information such as the FAT table and file entry is updated from that stored in PB0 of the nonvolatile memory banks 112 to 142, the management information is stored in PB705 of the nonvolatile memory banks 112 to 142 in the other free physical blocks. The management information may be stored in the other physical blocks other than PB 705 as long as they are free physical blocks.

As described above, the access module 200B multiplexes the musical sound data acquired from the Internet 310 and the like and allocates in the logical address space based on the memory structure information, and writes the musical sound data to the storage module 100B with the allocation. The storage module 100B which holds the musical sound data thus acquired is connected to the access module 200B. By producing sound according key-touch of the master keyboard 300, the tone can be easily updated.

Since the musical sound data stored in the storage module 100B is managed as a musical sound data file by the file system part 236, the musical sound data can be managed and edited by a device such as the personal computer based on a same file system (FAT file system). In addition, the musical sound data can be easily copied to other recording device or recording medium.

When a bad block occurs in writing the musical sound data to the nonvolatile memory banks 112 to 142, each memory controller may perform logical-physical conversion and rewrite the data in a free good block.

Although the access module 200B acquires the musical sound data written to the storage module 100B from the Internet 310, the musical sound data may be acquired from other device such as a personal computer.

As described above, in the musical sound generating system in the second embodiment, by recording the musical sound data in each of the nonvolatile memory banks 112 to 142, the musical sound data is multiplexed and the data reading part 240 reads the musical sound data in parallel from the plurality of nonvolatile memory banks. For this reason, in a system in which it cannot be predicted which pitch of musical sound data is required to be read, such as the musical sound generating system, a plurality of pieces of data can be read from the plurality of nonvolatile storage modules in parallel. Therefore, the sounding delay time can be made smaller than 1 msecond as its acceptable scope. In other words, even when the prevailing mass multi-level NAND flash memory is used as the memory for musical sound data, an inexpensive and compact musical sound signal generating device can be realized.

Furthermore, the musical sound generating system in the second embodiment is a system based on the FAT file system. The FAT file system is a general-purpose file system which can write the musical sound data by using the access module. The user can rewrite the musical sound data according to his/her preference, and therefore, the system is very versatile.

### Third Embodiment

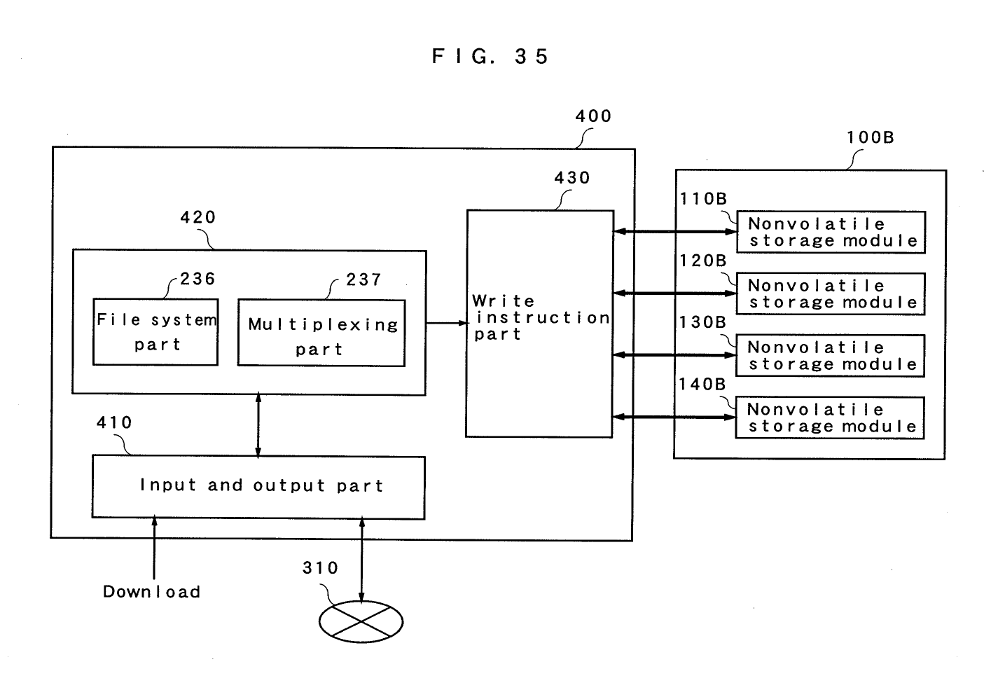

Next, a data writing system according to a third embodiment of the present invention will be described referring to FIG. 35. The data writing system in the present embodiment includes a data writing module 400 and storage module 100B. The storage module 100B is the same as the above-mentioned storage module 100B in the second embodiment. The data writing module 400 extracts the data writing function from the access module 200B in the second embodiment and, as shown in FIG. 35, includes an input and output part 410, a CPU part 420 and a write instruction part 430. The Internet 310 is connected to the input and output part 410 of the data writing module 400 so that necessary data may be downloaded according to the user's download instruction. The CPU part 420 includes the file system part 236 and multiplexing part 237 as in the second embodiment. Since the data writing module 400 performs the data writing processing same as that of the access module 200B in the second embodiment, detailed description thereof is omitted.

The data writing module 400 may be a device such as s personal computer or an access circuit module incorporated into a personal computer.

As described above, in the data writing module in the third embodiment, since the musical sound data multiplexed as a file can be written and managed, the tone can be easily updated by writing the musical sound data downloaded from the Internet and the like to the nonvolatile storage module. The musical sound data may be taken from any source other than the Internet.

### Forth Embodiment

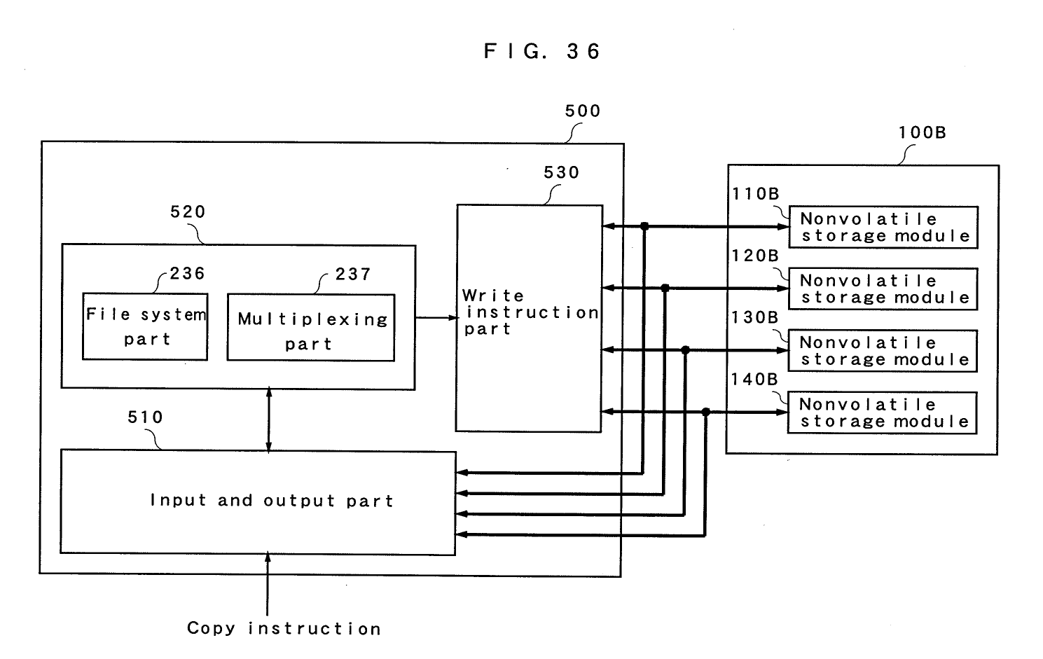

Next, a data writing system according to a forth embodiment of the present invention will be described referring to FIG. 36. The data writing system in the present embodiment includes a data writing module 500 and the storage module 100B. The data writing system in the present embodiment is basically the same as the data writing system in the third embodiment and a difference between the third and forth embodiments is that the source of the musical sound data is not the Internet 310, but one nonvolatile storage module in the storage module 100B. Here, data in the nonvolatile storage module 110B is written to the other modules and the former module is hereinafter referred to as a master storage module. The master storage module is a module which can be attached/detached to/from the data writing module 500.

When the nonvolatile storage module 110B is attached to the data writing module 500, an input and output part 510 determines that the attached nonvolatile storage module 110B is the master storage module. At this time, the file system part 236 of a CPU part 520 automatically reads the musical sound data stored in the master storage module and multiplexes the data by the multiplexing part 237. Then, the multiplexed data is written to the nonvolatile storage modules 110B to 140B according to control of a write instructing part 530. Since the data writing module 500 performs the data writing processing same as that of the access module 200B in the second embodiment, detailed description thereof is omitted. The input and output part 510 may determine the master storage module and start reading of the musical sound data according to a user's copy instruction.

Since the input and output part 510 determines the master storage module as described above, the file system part 236 can perform control so as not to write data to the master storage module again.

The data writing module 500 may be a device such as a personal computer or an access circuit module incorporated into a personal computer.

As described above, in the data writing module in the forth embodiment, since the musical sound data can be multiplexed, written and managed as a file, the tone can be easily updated by writing the musical sound data read from the master storage module to the nonvolatile storage modules.

Although data obtained by digitally recording piano sound is recorded in the nonvolatile memory banks 112 to 142 as the musical sound data in the embodiments 1 to 4, musical instrumental sound other than piano sound or voice, or other data may be stored. The musical sound data is not limited to the digitally-recorded data and may be artificial data. In addition, data compressed by a compressing technique such as MP3 may be used. However, in this case, the signal processing part 220 needs to perform processing of extending the compressed data, that is, decode processing. Although two types of musical sound data corresponding to the strength of key-touch are previously stored, one or three or more types of musical sound data may be stored. However, in the case of one type, the interpolating processing by the signal processing part 220 is unnecessary and in the case of three types, the method of interpolating processing may be extended to linearly interpolation between three points. Filtering processing, not interpolating processing, may be adopted.

Although the length of the musical sound data corresponding to one key is defined as about 40 seconds, the time length of the musical sound data is not limited to 40 seconds and may be changed depending on the NN. Generally, in the piano, since the sounding time is longer as the note is lower, when the time length of the musical sound data on lower notes are made relatively long and the time length of the musical sound data on higher notes are made relatively short, a storage capacity is preferably improved. Although the same musical sound data is recorded in the nonvolatile memory banks 112 to 142 in multiplexing of the musical sound data, as long as it sounds acoustically same, the value of the musical sound data may be slightly different among the nonvolatile memory banks 112 to 142.

The storage modules 100A, 100B each is a removable storage device such as a memory card or memory part incorporated into a device such as an electronic musical instrument. The access modules 200A, 200B each may be a device such as an electronic musical instrument or access circuit part incorporated into a device such as an electronic musical instrument.

In embodiments 1 to 4, although the number of nonvolatile storage modules is four, the other number is possible. As the number of nonvolatile storage modules is greater, the sounding delay time can be reduced. Although the sector size, that is, size of the musical sound data read once, is 512 Bytes, the other size is possible. As the size is smaller, the RAM capacity of the musical sound data buffer can be improved, but when the size is made smaller than necessary, musical sound generating processing fails. A plurality of nonvolatile memory banks may be provided in one nonvolatile storage module.

In embodiments 1 to 4, as shown by S202 to S208 in FIG. 14A, although the nonvolatile storage module to which the read instructing information is transferred is determined depending on the assignment statuses of the group of the nonvolatile storage modules, for example, relationship between the CHN and MMN may be fixed as represented by following (a) to (d).

(a) CH0, 4, 8, 12, 16, 20, 24, 28

MM0 (nonvolatile storage modules 110A, 110B)

(b) CH1, 5, 9, 13, 17, 21, 25, 29

MM1 (nonvolatile storage modules 120A, 120B)

(c) CH2, 6, 10, 14, 18, 22, 26, 30

MM2 (nonvolatile storage modules 130A, 130B)

(d) CH3, 7, 11, 15, 19, 23, 27, 31

MM3 (nonvolatile storage modules 140A, 140B)

Although the musical sound data is continuously arranged in the page, the musical sound data may be discontinuously arranged as long as the storage modules 100A, 100B and access modules 200A and 200B recognize regularity of the arrangement. Although the musical sound data is sequentially arranged from the lowest sound using PB0 as the leading block in the first embodiment, the leading block is not limited to PB0 and the musical sound data may be discontinuously arranged as long as the storage modules 100A, 100B and access modules 200A, 200B recognize regularity of the arrangement.

Although the nonvolatile memory bank is assumed to be the flash memory, the present invention can be also applied to a case where other types of nonvolatile memories are used.

Although the musical sound data characteristic information and memory structure information are held in the nonvolatile memory bank, another nonvolatile memory which holds the information therein may be provided. Alternatively, said memory structure information may be handled as previously standardized information.

The memory controllers 111A, 111B to 141A, 141B may be provided in the access module 200A or 200B. In this case, the nonvolatile memory banks 112 to 142 are each packaged in one memory chip. Alternatively, two or more nonvolatile memory banks 112 to 142 are collectively packaged in one memory chip.

Although the musical performance information is inputted from the master keyboard 300, other form of input controller, for example, a guitar-type controller of outputting musical performance data by playing strings, a stick-type controller of outputting musical performance data by hitting an object, or a controller provided with an acceleration sensor of outputting musical performance data by a swing operation may be used. Furthermore, musical performance data such as a standard MIDI file may be inputted to the access module 200B from a device such as a personal computer or through network.

### INDUSTRIAL APPLICABILITY

The musical sound generating system of the present invention provides the nonvolatile memory as a memory for musical sound data and is useful for an electronic musical instrument, a karaoke machine, a personal computer or a mobile phone which have a musical sound generating function (for example, sound card).

1. An access module for providing a read instruction to a plurality of nonvolatile storage modules recording multiplexed musical sound data therein comprising:
a read instructing part for reading data from any of said nonvolatile storage modules according one external sounding instruction, and parallely reading data from the nonvolatile storage module other than the reading nonvolatile storage module when another sounding instruction is provided before the reading is completed.

2. The access module according to claim 1, wherein
said access modules further comprises a CPU part for assigning a plurality of external sounding instructions to a plurality of sounding channels, and
said read instructing part provides a read instruction to any of said plurality of nonvolatile storage modules based on the plurality of sounding channels assigned by said CPU part.

3. The access module according to claim 1, wherein said read instructing part includes a channel register for registering a state of said read instruction to said nonvolatile storage module for each sounding channel.

4. The access module according to claim 1, wherein said read instructing part includes an MM register for registering access state for each of said nonvolatile storage modules.

5. The access module according to claim 1, wherein
at least one of said plurality of nonvolatile storage modules holds recorded data characteristic information including at least information on a sampling frequency of said musical sound data therein, and
said access module further comprises an input and output part for performing music sound generating processing based on said recorded data characteristic information acquired from said nonvolatile storage module.

6. An access module for performing reading and writing with respect to a plurality of nonvolatile storage modules comprising:
a CPU part including a multiplexing part for multiplexing musical sound data acquired from outside and a file system part for managing musical sound data held in said plurality of nonvolatile storage modules as a file;
a write instructing part for recording said musical sound data multiplexed by said multiplexing part in said plurality of nonvolatile storage modules; and
a read instructing part for reading data from any of said nonvolatile storage modules according one external sounding instruction, and parallely reading data from the nonvolatile storage module other than the reading nonvolatile storage module when another sounding instruction is provided before the reading is completed.

7. The access module according to claim 6, wherein said CPU part has a function of assigning a plurality of external sounding instructions to a plurality of sounding channels, and
said read instructing part provides a read instruction to any of said plurality of nonvolatile storage modules based on the plurality of sounding channels assigned by said CPU part.

8. The access module according to claim 6, wherein said read instructing part includes a channel register for registering the state of said read instruction to said nonvolatile storage module for each of said sounding channels.

9. The access module according to claim 6, wherein said read instructing part includes an MM register for registering an access state for each of said nonvolatile storage modules.

10. The access module according to claim 6, wherein
at least one of said plurality of nonvolatile storage modules holds recorded data characteristic information including at least information on a sampling frequency of said musical sound data therein,
said access module further comprises an input and output part for performing music sound generating processing based on said recorded data characteristic information acquired from said nonvolatile storage module.

11. A storage module comprising: a plurality of nonvolatile storage modules each recording the same musical sound data therein, and reading data in parallel according to an external read instruction.

12. A musical sound generating system comprising:
an access module; and
a plurality of nonvolatile storage modules for reading data in parallel according to a read instruction from said access module, wherein:
said plurality of nonvolatile storage modules each record the same musical sound data; and
said access module includes a read instructing part for reading data from any of said nonvolatile storage modules according one external sounding instruction, and parallely reading data from the nonvolatile storage module other than the reading nonvolatile storage module when another sounding instruction is provided before the reading is completed.

13. The musical sound generating system according to claim 12, wherein said nonvolatile storage module includes a multi-level NAND flash memory as a memory bank.

14. A musical sound generating system comprising:
an access module; and
a plurality of nonvolatile storage modules for reading data in parallel according to a read instruction from said access module, wherein:
said plurality of nonvolatile storage modules each record the same musical sound data; and
said access module includes:
a CPU part including a multiplexing part for multiplexing musical sound data acquired from outside and a file system part for managing musical sound data held in said plurality of nonvolatile storage modules as a file;
a write instructing part for recording said musical sound data multiplexed by said multiplexing part in said plurality of nonvolatile storage modules; and
a read instructing part for reading data from any of said nonvolatile storage modules according one external sounding instruction, and parallely reading data from the nonvolatile storage module other than the reading nonvolatile storage module when another sounding instruction is provided before the reading is completed.

15. The musical sound generating system according to claim 14, wherein said nonvolatile storage module includes a multi-level NAND flash memory as a memory bank.

16. A data writing module connected to a plurality of nonvolatile storage modules for writing musical sound data comprising:
a multiplexing part for multiplexing musical sound data acquired from outside;
a file system part for managing said musical sound data multiplexed by said multiplexing part as a file; and
a write instructing part for writing said musical sound data multiplexed by said multiplexing part to said plurality of nonvolatile storage modules.

17. A data writing module connected to a plurality of nonvolatile storage modules for writing musical sound data comprising:
a multiplexing part for multiplexing musical sound data acquired from any of said plurality of nonvolatile storage modules;
a file system part for managing said musical sound data multiplexed by said multiplexing part as a file; and
a write instructing part for writing said musical sound data multiplexed by said multiplexing part to the other nonvolatile storage module of said plurality of nonvolatile storage modules.

18. The data writing module according to claim 17, wherein said data writing module further includes an input and output part for detecting that any of connected nonvolatile storage modules holds musical sound data.
